(19) United States
(12) Patent Application Publication
(10) Pub. No.: US 2013/0024290 A1
(43) Pub. Date: Jan. 24, 2013

(54) METHOD AND APPARATUS FOR MANAGING SALES PROMOTIONS AND GENERATING CUSTOMER LEADS

(71) Applicants: Scott C. Berg, San Diego, CA (US); Bradley R. Molenda, San Diego, CA (US)

(72) Inventors: Scott C. Berg, San Diego, CA (US); Bradley R. Molenda, San Diego, CA (US)

(73) Assignee: MOTIVA79 LLC, San Diego, CA (US)

(21) Appl. No.: 13/525,207

(22) Filed: Jun. 15, 2012

Related U.S. Application Data
(60) Provisional application No. 61/498,466, filed on Jun. 17, 2011.

(51) Int. Cl. G06Q 30/02

(52) U.S. Cl. 705/14.66

(57) ABSTRACT

A method and apparatus for managing business promotion and customer lead generation by providing for integration and synchronization of activities such as generation of promotional information such as business profiles, marketing elements and promotional communications, facilitating the optimization of promotional information for search, distributing promotional items through informational channels and media platforms, gathering and receiving information and data from viewers of these items via the informational channels and media platforms, providing for the sale of products and services, storing the promotional information and viewer information and providing for connectivity between the informational channels and media platforms so that the stored promotional and viewer information and data are easily transferable to the informational channels, media platforms, and providing for analysis of the effectiveness of the integrated and synchronized business promotion and lead generation.

### CROSS-REFERENCE TO RELATED PATENT APPLICATIONS

This application claims priority under 35 U.S.C. §119(e) to U.S. Provisional Patent Application Ser. No. 61/498,466 filed Jun. 17, 2011.

### TECHNICAL FIELD

The present application relates generally to advertising and promotion, and more particularly, to apparatuses and methods for developing, integrating, managing and analyzing the performance of business promotional activities and customer lead generation.

### BACKGROUND

Business marketing via the Internet, social networks, and electronic communications such as email, SMS, instant or social messaging, and other formats, for example, allow companies to reach increasingly greater numbers of actual and potential customers. Effective business promotion involves various media platforms, informational channels, areas of marketing and tools, such as website design, search engine marketing, social media and social networking, advertising (including online and electronic advertising channels such as pay-per click, display, and mobile), lead generation, data analytics, and engaging customers and prospects via the World Wide Web and other communication channels, electronic or otherwise. Existing systems provide expertise and technological solutions to help businesses develop promotions and advertisements for such media, distribute and make them visible to customers, and to generate sales leads in order to propel business growth. Particularly for businesses without significant experience or “in-house” capabilities in this area, such systems offer marketing expertise as well as tools and methods to improve marketing efficiency. The marketing, lead-generation, and promotional solutions provided by such systems allow businesses to improve and scale up their online and electronic marketing capabilities, without diluting their focus on strategic execution, business management, and their particular core competencies.

Technology-driven systems facilitate the efficient creation, delivery and execution of online and electronic promotional campaigns and the generation of customer leads. Existing systems are often specialized and focus on one or two individual aspects of online promotional activity, such as providing promotional expertise and consultation to businesses, building websites, developing promotional materials, optimizing search engine visibility, developing and pushing targeted electronic communications to prospects and customers, capturing and aggregating information provided by customers and prospects, or analyzing the effectiveness of promotional activity. It is typical for such systems to address and execute only one or a few of these specific promotional activities. The specialized focus of such systems can help businesses improve specific areas of marketing, promotion and lead generation performance such as social networks, email marketing, website development, or search engines, for example.

Thus, to fill gaps in particular areas of an online marketing strategy such as website building or search engine optimization, a business may engage or employ several discrete, specialized, non-integrated systems. Engaging or utilizing multiple non-integrated systems, however, does not provide for seamless customized creation and synchronized distribution of promotional content across multi-media channels and integration with lead generation activity. For example, attempting to transfer data between systems that are incompatible or interface poorly may result in inefficiencies or require redundant efforts to input and transfer data. Discrete systems from different providers may not interconnect or communicate well with each other, potentially corrupting data or requiring repetitive input and reformatting of customer data, promotional content and advertising messages. Utilizing multiple discrete systems for particular tasks may not allow for easy generation of templates or reuse of previously generated marketing campaigns and messages across differing system platforms.

Simply put, discrete, specialized systems may not facilitate the seamless transfer of customer data, marketing messages and materials, throughout all facets of a marketing campaign where the information and materials are needed. As a specific example, a particular coupon or promotional webpage generated by one provider's system may not integrate with a separate system that a business employs to distribute such information to prospects. Incorporating a third system to capture customer data and generate leads, may introduce additional communication and compatibility problems with either or both of the first two systems.

In summary, existing business marketing systems are specialized and typically geared toward one or a few aspects of marketing or promotion, such as website development, social media, particular forms of advertising, electronic communications and Internet search, rather than providing synchronized comprehensive end-to-end marketing solutions. While employing existing specialized systems can enhance the capabilities of a business in particular areas, it may be difficult to integrate such systems with each other, and with other systems in a way that facilitates the seamless transfer of promotional content, messages, data, and information between and among these systems. Attempting to integrate existing specialized tools and systems that are tailored for specific marketing and lead generation activities often represents a piecemeal approach that does not result in a comprehensive, integrated and synchronized promotional and lead generation campaign.

### SUMMARY

Various aspects of examples of the invention are set out in the claims.

In one aspect, the invention relates to a method comprising: (a) generating one or more business profiles based on content provided by a user; (b) generating at least one marketing element based on content provided by the user; (c) gathering information related to at least one viewer of at least one of the following: (1) one of the one or more business profiles; or (2) at least one marketing element; (d) analyzing the information related to the at least one viewer, the information relating to at least one of the following: (1) viewer characteristics or (2) viewer actions; (e) making data related to the information available to the user.

In an embodiment, gathering information relates to distributing at least one of the following through at least one informational channel: (1) one of the one or more business profiles or (2) at least one marketing element.

In an embodiment, information related to at least one viewer is gathered via at least one informational channel.

In an embodiment, making data related to the information available to the user includes quantifying performance metrics based on analysis of information related to at least one viewer.

In an embodiment, making data related to the information available to the user includes making the performance metrics available to the user.

In an embodiment, at least one of the following is stored: (1) the user-provided content; (2) at least one of the one or more business profiles; or (3) at least one marketing element.

In an embodiment, distributing business profiles and marketing elements relates to generating at least one linked set, each set including at least one of the at least one marketing element and at least one of the following: (1) one of the one or more business profiles; or (2) at least one other marketing element.

In an embodiment, distributing business profiles and marketing elements includes linking at least one linked set to at least one media platform for distribution to at least one viewer via the at least one media platform.

In an embodiment, gathering information and distributing business profiles and marketing elements relates to generating a suite of promotional materials based on content provided by a user, and providing at least one other user with access to at least a portion of the suite; wherein the access includes authorization to at least one of: (1) customize the promotional material; or (2) distribute the customized promotional materials through informational channels.

In an embodiment, gathering information and distributing business profiles and marketing elements relates to providing at least one other user with authorization to link customized promotional material to at least one media platform for distribution to viewers via the media platform.

In an embodiment, the business profile and marketing elements may be optimized for ease of searchability via search engines.

In an embodiment, at least one of the following may be made available for sale to at least one viewer, through an informational channel: (1) one or more products; or (2) one or more services.

According to a second aspect of the present invention, an apparatus comprises at least one processor; and at least one memory including computer program code, the at least one memory and the computer program code configured to, with the at least one processor, cause the apparatus to perform at least the following: (a) generate one or more business profiles based on content provided by a user; (b) generate at least one marketing element based on content provided by the user; (c) gather information related to at least one viewer of at least one of the following: (1) one of the one or more business profiles; or (2) at least one marketing element; (d) analyze the information related to the at least one viewer, the information relating to at least one of the following: (1) viewer characteristics or (2) viewer actions; and; (e) make data related to the information available to the user.

According to a third aspect of the present invention, a computer program product, embodied on a non-transitory computer-readable medium, comprising: computer code for causing an apparatus to perform at least the following: (a) generating one or more business profiles based on content provided by a user; (b) generating at least one marketing element based on content provided by the user; (c) gathering information related to at least one viewer of at least one of the following: (i) one of the one or more business profiles; or (ii) at least one marketing element; (d) analyzing the information related to the at least one viewer, the information relating to at least one of the following: (i) viewer characteristics or (ii) viewer actions; and (e) making data related to the information available to the user.

### BRIEF DESCRIPTION OF THE DRAWINGS

For a more complete understanding of example embodiments of the present invention, reference is now made to the following descriptions taken in connection with the accompanying drawings in which:

FIG. 1 is a flow chart illustrating a method according to one embodiment;

FIG. 2 is a block diagram illustrating an example embodiment of the invention;

FIG. 3 is a block diagram illustrating an example embodiment of the invention;

FIG. 4A is a block diagram illustrating an example embodiment of the invention;

FIG. 4B a block diagram illustrating an example embodiment of the invention;

FIG. 5 is a screenshot depicting a “dashboard” user interface in accordance with an embodiment;

FIGS. 6A and 6B are screenshots depicting data entry interfaces in accordance with an embodiment of the invention;

FIG. 7A-7B are screenshots depicting a “business profile” interface in accordance with an embodiment of the invention;

FIGS. 8A-8C are screenshots depicting a “promotion component” interface in accordance with an embodiment of the invention;

FIGS. 9A and 9B are screenshots depicting a “coupon component build” interfaces in accordance with an embodiment of the invention;

FIG. 10A is a screenshot depicting a page for interfacing with Constant Contact® in accordance with an embodiment of the invention;

FIG. 10B is a screenshot depicting a page for interfacing with Facebook® and Twitter® in accordance with an embodiment of the invention; and

FIG. 11 illustrates an exemplary device within which the various embodiments may be implemented.

While the present invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTON OF THE DRAWINGS

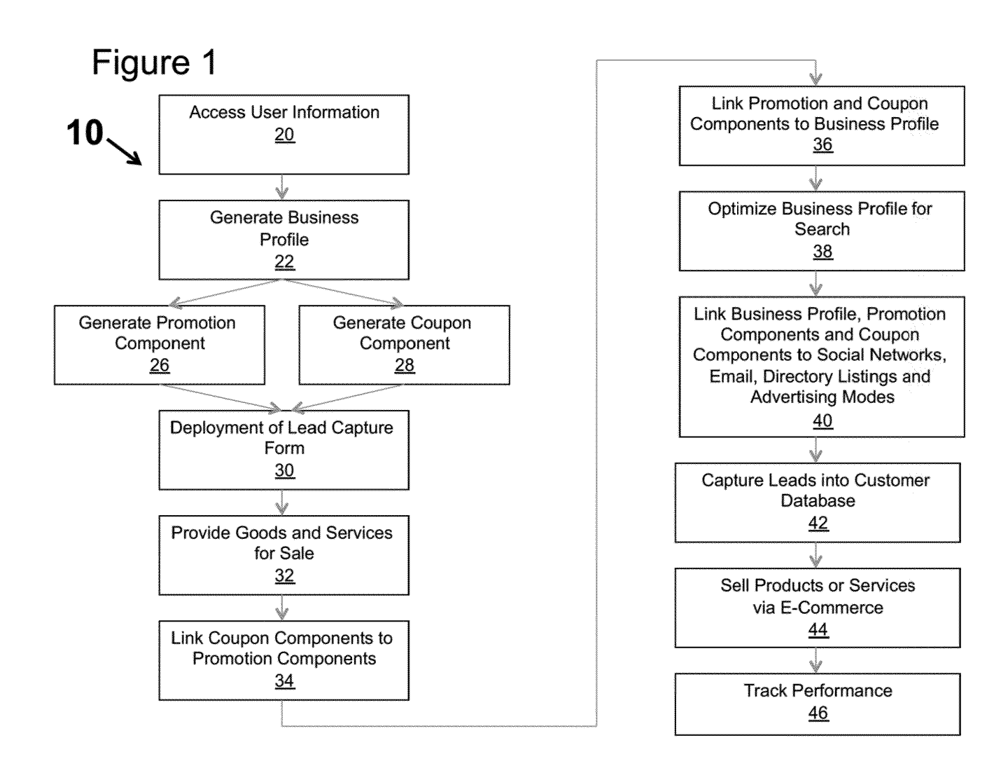

Example embodiments of the present invention and their potential advantages are understood by referring to FIGS. 1-11 of the drawings.

A solution that provides for synchronized business promotion and integrated overall management of a customer engagement and retention process enables businesses to improve the effectiveness and efficiency of their marketing, particularly online and electronic marketing. Significant efficiencies in promotion and lead generation may be achieved through a single, comprehensive solution that facilitates automated centralized creation, management, execution, synchronization and updating of promotional campaigns and integrates customer lead generation activities. Such an integrated solution enables businesses to engage customers in a synchronized manner through various media and informational channels (whether online, electronic, or otherwise), manage the capture, storage and use of customer and prospect information throughout all promotional aspects and functions, and analyze and optimize the performance of promotional campaigns.

A turnkey solution enables users to implement and manage an end-to-end marketing program to increases sales and generates valuable customer leads in an efficient manner. Various embodiments provide systems and methods for the design of promotional campaigns and seamless integration of such campaigns with databases, networks and media and informational channels to engage existing and prospective customers with customized promotional materials. The various embodiments facilitate connectivity with tools and media and informational channels which may be useful for promotion, such as, among others, content creation and management, social networking, advertising, directory listings, targeted transmission of messages via electronic communications media (e.g., email, SMS, instant or social messaging, etc.), application of business intelligence, and response tracking.

Various embodiments provide for the receipt of user input regarding the creation of campaigns and certain operational parameters. As such, embodiments may have flexibility to receive and operate with various levels of user input, depending on the user's promotional expertise and available time. For example, embodiments facilitate engagement and communication with various other components and tools, both internal and external, to execute end-to-end promotional campaigns in accordance with user preferences and input. Customized promotions may also be designed, based on the level and scope of a user's input, to engage prospective customers through interfaces with external networks and media and informational channels. In addition, embodiments may provide for the collection and aggregation of contact and other information provided by engaged prospects and customers into a storage medium, such as, for example, into a database, thus providing an easily retrievable set of promising customer leads to the user, as well as feedback regarding the results and performance of a promotional campaign. Embodiments may also provide for such storage of user input data, as well as promotional materials and communications, for seamless retrieval and utilization throughout the internal promotional elements and components, as well as throughout external networks and media and informational channels.

Thus, embodiments provide a comprehensive solution for the creation and overall management of a business promotion and customer engagement and lead generation process.

Referring now to FIG. 1, a flowchart illustrates a method according to an embodiment. Various operations shown in FIG. 1 may be performed in the order depicted or in some other order. In accordance with the method of FIG. 1, an integrated promotion and lead generation process 10 begins at block 20, as information is received from a user, or user information is accessed. At block 20, a user can directly input, upload, download, import or otherwise enter information such as a user's name, credit card or other payment information, as well as user settings and preferences, additional user contact information, business/industry information (e.g., NAICS information), and other identifying or descriptive information. In an embodiment, a user may be prompted for information and may enter information via a user interface such as a webpage or a “click to complete” interface (as described in greater detail, below), for example. In another embodiment, such information, or grouped elements of such information may be uploaded in a consolidated file format, such as a spreadsheet, for example. Information entered by a user may be stored in a storage medium, such as a database or other known storage medium, and a user account may be created that includes security features such as a unique username and password setup, for example. In an embodiment, quick retrieval and access of a user's previously input, stored information may be facilitated through an abbreviated login procedure, so that a user can avoid time-consuming re-entry of previously entered information. Numerous security features are known in the art for limiting and providing access to stored user information, and a detailed description of such features is not required to understand the embodiments.

In another embodiment, a user may be required to originate and pay a fee for a time-limited subscription, which includes and provides for the storage of user information and access to various features and functionality of the embodiment.

Referring again to FIG. 1, a business profile may be generated at block 22. The business profile may be generated based on additional user input received at this step, or based on user input that has been entered by a user at an earlier time and stored, such as when a user enters information at block 20, for example. Creating a user account, as discussed above, may facilitate the storage of user information so that a user can quit entering data before a complete business profile is generated, store the information entered to that point, and return at a later time to finish entering the information for the business profile. The user input for the business profile may include items such as a business logo, business address and contact information, information about the products and services offered by the business, and other descriptive information relating to the business. The user may be prompted or requested to input particular items in a particular sequence, or randomly. In an embodiment, a user may be prompted for and enter information, preferences and other input regarding a business profile via a user interface such as a webpage, or a “click to complete” interface (as described in greater detail, below), for example or such input and information may be imported, uploaded, downloaded, or entered in any other manner as may be known in the art. In another embodiment, such information, or grouped elements of such information may be uploaded in a consolidated file format, such as a spreadsheet, for example.

In an embodiment, a user may be presented with, or may access, a predetermined set of business profile templates, which provide for displaying information entered by the user in various configurations that may reflect a customary profile configuration for a type of business, or a particular aesthetic. A user may also be provided with choices for typefaces, fonts, text and background colors, layouts, etc., which appear in the template, so that the resulting business profile may be further customized to user preferences. In an embodiment, a business profile may be generated and customized as a webpage or in another format suitable for transmittal and display through various electronic data transmission modes and media. A business profile may also be automatically formatted, based on user input and the user's selection of predetermined templates and format choices, for display or publication on various electronic media, such as computer screens, electronic tablets, smartphones, PDAs or other such devices which may be connected to networks such as the Internet. Various methods and practices for developing and generating business profiles and business profile webpages based on user input are well known in the art. Detailed descriptions of such methods and practices are beyond the scope of this disclosure and are not required to understand various embodiments of the invention.

A business profile may be thus be generated, automatically formatted, and displayed to a viewer in many forms, and through various types of media. In addition, once generated, a business profile may be stored or saved for future access or retrieval by various features and functionality of embodiments of the invention, as well as for other uses, such as a template or a starting point for generating a new business profile.

An embodiment of the invention provides for the generation of marketing elements, such as promotion components and coupon components. As illustrated in FIG. 1, one or more promotion components and one or more coupon components may be generated at blocks 26 and 28. As discussed above in connection with a business profile, a promotion or coupon component may be generated and customized based on various types of user input received at this step through various methods, or a promotion or coupon component may be based on user input that has been received at an earlier time and stored, such as, for example, a business profile or user input upon which a business profile was based. In an embodiment, promotion components and coupon components may be generated and customized as unique webpages or in other formats suitable for transmittal and display through various electronic data transmission modes and media as is discussed above, in connection with the transmittal and display of business profiles. A promotion component may include a marketing message or other communication, accompanied by related information that is geared toward marketing and promoting the business to customers and prospects. A coupon component may include a discount or other incentive that is geared toward enticing a customer or prospect to purchase goods or services from the business. A user may make selections and customize promotion and coupon components in similar fashion as is described above in connection with the business profile. In an embodiment, a user may be prompted for information and may enter information regarding a promotion component or a coupon component via a user interface such as a webpage or a “click to complete” interface (as described in greater detail, below), for example, or such input and information may be imported, uploaded, downloaded, or entered in any other manner as may be known in the art.

In an embodiment, promotion components and coupon components may be generated and customized, based on user input and a user's selection of predetermined templates and format choices, as user interfaces such as webpages, or in other formats suitable for display or publication on various types of computer displays and mobile electronic devices, such as electronic tablets, smartphones PDAs and any other such devices which may be connected to networks such as the Internet. Promotion components and coupon components may also be generated as smaller graphical items that are incorporated into other webpages (e.g., such as a business profile webpage), to appear when the primary website is visible, or may be configured to appear in response to viewer input or when a particular button or hyperlink is clicked. It is to be appreciated that methods and practices for developing, generating and linking promotion component webpages and coupon component webpages based on user input are well-known in the art and descriptions of such methods and practices are not required to understand embodiments of the invention. Once generated, promotion components and coupon components may be stored or saved for access or retrieval by various features and functionality of embodiments of the invention, as well as for other future uses, such as a template or a starting point for generating a new promotion components and coupon components.

In an embodiment, the business profile, promotion components and coupon components may function as building blocks of a customized lead generation program. In such an embodiment, the business profile, promotion components and coupon components may be linkable to each and may thus form linked sets. These items can be linked in various configurations to create synchronized lead-generation “pathways” and “funnels.” For example, a business profile generated as a webpage may be linked to, and thus display a number of promotion components or coupon components, or hyperlinks leading to these items. Similarly, a promotion component generated as a webpage may be linked to, or display a number of coupon components or hyperlinks leading to a coupon component. By accessing a coupon component on the Web, and clicking on a hyperlink leading to a promotion component, a viewer may be quickly transported to the promotion component. In similar fashion, hyperlinks on any of the business profile, promotion component or coupon component may lead a viewer to any other respective components that are so linked.

In an embodiment, lead generation (as discussed in greater detail, below) may be facilitated when a viewer of a marketing element is required to provide the viewer's contact information in order to activate a discount or other incentive described on the coupon component, or to print the coupon. In another embodiment, a viewer of a coupon component may be offered a discount or other incentive that may only be used in an electronic commercial transaction (e-commerce) to purchase specific discounted goods or services. As will be described in further detail below, data gathered from the viewers of promotion components and coupon components may be collected and stored, and utilized to further synchronize the interaction between combinations of business profiles, promotion components and coupon components. In addition, the data collected from viewers may be analyzed to measure and quantify lead generation and sales conversion data to optimize performance of the lead generation “funnel,” i.e., whether elements of a business profile, promotion component or coupon component are effective in leading a viewer to view another promotion or coupon component, visit a business profile, purchase an item via electronic commerce, or to submit viewer information.

In an embodiment, several promotion components and coupon components may be generated or combined, with or without a business profile, into a unified campaign. As such, even though each promotion component or coupon component is separate from the other items in a campaign, the appearance of the respective promotion components and coupon components may reflect a common theme or formatting, or some common elements may be included in each item associated with a campaign. In another embodiment, the deployment of individual promotion components and coupon components in a campaign may be particularly timed or sequenced to achieve a particular goal or target. These examples are provided only to illustrate embodiments, and not for limitation of embodiments of the invention.

In an example embodiment of the invention, a user may be provided with an opportunity to capture information that may be useful in generating customer leads. As seen at block 30 of FIG. 1, a lead capture form may be deployable, at a user's election and direction, for presentation to viewers of business profiles or marketing elements. A lead capture form is a form that prompts such a viewer to provide specific information. In an embodiment, a lead capture form may be presented to a viewer of a business profile or marketing element via a computer or other electronic device, either automatically, or in response to a viewer clicking on hyperlinks or accessing other functionality. The lead capture form may be presented to a viewer via an electronic interface that is presented to users of electronic computing or mobile devices in a “click and complete” format (discussed in greater detail below), where a viewer enters responsive information using the device's input tools and submits the information electronically. In another example embodiment, a user may be prompted by any other known data-gathering tool for requesting a viewer to provide such information. The information requested may include items such as a viewer's name, e-mail address, company information (NAICS), address, date of contact, etc. An example embodiment of the invention may provide for the automatic entry of information on the lead capture form into a database after its capture. Various methods for presenting a lead capture form to a viewer or otherwise prompting a viewer to enter data, and gathering and storing information captured from the viewer are known, and a detailed description of such methods is beyond the scope of this disclosure and not needed for understanding certain embodiments of the invention.

In an example embodiment, marketing elements such as promotion components and coupon components may be generated with built-in lead capture forms. A lead capture form may thus be linked to, or be part of a linked set with, a promotion or coupon component for automatic deployment to a viewer when the respective marketing element is accessed. In an embodiment, the appearance and data items requested by the lead capture form are predetermined. In another embodiment, a lead capture form may be generated or customized based in user input, in similar fashion as the generation of business profiles or marketing elements, as discussed above. A lead capture form may be linked to a database or other storage medium so that when a viewer provides the information requested and submits or returns the completed lead capture form, the information is automatically stored, in a format that is sortable for further use, follow-up, analysis and promotion optimization, in similar fashion to the storage, retrieval and access of user input, business profiles and other items as discussed above.

In another embodiment, goods and services may be offered for sale to viewers of business profiles, promotion components and coupon components through electronic commerce (E-commerce), for example, at a user's selection and direction, as shown at block 32 of FIG. 1. Generally, e-commerce refers to methods and systems that facilitate the purchase of goods and services through electronic devices such as computers, tablets, PDA's smartphones and the like. Such methods and systems typically provide for the display or description of the items on sale, as well as providing for payment by the purchaser, often by accepting credit card information or utilizing services such as PayPal™ and others. Numerous e-commerce methods and systems are known. Detailed descriptions of e-commerce systems are beyond the scope of this disclosure and are not necessary to understand certain embodiments of the invention. In an embodiment, such goods and services, and the opportunity to purchase them may be provided to viewers directly from the business profile, promotion component, or coupon component. In another embodiment, such goods and services and the opportunity to purchase them may be offered through a dedicated e-commerce system that may be accessible by hyperlinks, or alternate access methods, from the respective business profile, promotion component or coupon component. Such a dedicated e-commerce system may also be interfaced with an embodiment to provide for storage of customer information gathered as described in connection with other embodiments herein.

Referring again to FIG. 1, in an embodiment of the invention, a user may input specific direction for one or more coupon components to be linked to one or more promotion components, as shown at block 34. Block 36 illustrates that a user can input instructions or a preference that results in one or more promotion components and one or more coupon components to be linked to a business profile in a linked set. This may be done, for example, by providing hyperlinks on business profiles, promotion components and coupon components that are generated as webpages. By clicking on a hyperlink included on a business profile that is a webpage, a viewer opens up or jumps to another webpage, for example, a promotion page or a coupon page. Hyperlinks may thus be included on any webpage that is a business profile, a promotion component or a coupon component, to facilitate linking from the viewed page to another page (e.g., another business profile, promotion component or coupon component, or any other page so linked to the viewed page). Such linking thus enables a viewer of a business profile to quickly and directly access linked promotion components and coupon components, and vice versa. Similarly, a viewer of a promotion component may be enabled to directly access any coupon components linked to the promotion component, such as in a linked set.

In an example embodiment of the invention, modification, or “optimization” of business profiles, promotion components and coupon components to be easily found by viewers may be facilitated, at a user's selection and direction, as seen at block 38. For example, utilizing interfaces such as “click and complete” webpages, or other editing functionality, a user may provide input or direction regarding key-word searchability of a business profile webpage, promotion component webpage or coupon component webpage that the user is generating or has previously generated and retrieved from storage. Such user input may cause the business profile, promotion component or coupon component, in whole or in part (e.g., particular elements of such items, such as text, videos, presentations, etc., for example, may be independently accessible in response to search engine queries, as well), to appear in response to a viewer's input of particular terms into an Internet search engine (e.g., Google®, Bing®, etc.), as is known in the art. Since search engines may be utilized on various types of electronic devices, including mobile devices and tablets, an embodiment of the invention may automatically provide for formatting of business profiles, promotion components and coupon components, as well as lead generation forms and other such items, or elements of any such items that may be independently accessible, so that these appear appropriately formatted when accessed through search results appearing on such devices. It is to be appreciated that Internet search encompasses all areas and items that are searchable, such as keyword, video, mobile and social, for example. Various methods are known in the art for optimizing website “searchability” via Internet search engines, and for facilitating the display and accessibility of webpages and content on various electronic devices. Detailed description of such methods is beyond the scope of this disclosure, and not required to understand embodiments of the invention.

Optimized searchability and delivery of business profile webpages, promotion component webpages and coupon component webpages over the Internet thus improves access of these items to viewers, as well as other components linked to these items, such as in linked sets, and, potentially, the lead capture form described above. As discussed above, information and data gathered and received from a viewer accessing such items over the Internet may be stored or saved in a database for further use, follow-up, analysis and promotion optimization.

An example embodiment of the invention may provide for the distribution and transmittal of business profiles, promotion components, coupon components and related information and links through optimization for Internet search, and integration with independently-existing electronic content distribution channels and media and informational channels such as social networks, email platforms, directory listings, and other advertising media that the user selects (whether accessible or enabled through wired, wireless, mobile or other functionality as is known in the art). For example, pay-per-click advertising and display advertising, such as through banner ads, for example, are popular ways to publish marketing information over the Internet for viewing on internet-enabled devices such as computers, tablets and smartphones, whether connected through wired or wireless connections. Mobile advertising is another way of delivering marketing and promotional content to mobile wireless-enabled devices such as PDAs, tablets, smartphones, and laptops.

Integration with such distribution networks and channels, as provided by an example embodiment, results in seamless connectivity and information transmission with and through such networks and media, as discussed in greater detail, below. As an example illustrated at block 40 of FIG. 1, business profiles, promotion components and coupon components, or related hyperlinks, may be seamlessly distributed and communicated directly to a user's social media, directory listing, advertising and other accounts to facilitate posting of such items on a user's social media pages (e.g., Facebook®, Twitter®), online pay-per-click advertising pages (e.g., Google®, Yahoo!®, Bing®), display advertising, and mobile advertising, as well as paid directory listing services (e.g., Yahoo!®Local, Yelp®). An embodiment may facilitate the automatic generation of content from stored business profiles, promotion components, and coupon components. Such content may be automatically generated and formatted as ready to deploy via such social media, directory listing and advertising services and networks. In an example embodiment, the content of previously created business profile or marketing element may be automatically accessed when a user provides input or direction to post a promotional message on a social network. In such an embodiment, the previously created promotion component content may be automatically converted to a marketing message suitably formatted for the particular medium or channel, and a link to the promotion component may be automatically added.

Also as illustrated at block 40 of FIG. 1, functionality may be provided for a user to send promotional messages and content to targeted recipients via e-mail (e.g., through an email platform such as Constant Contact®, for example), SMS (e.g., Twitter®), instant message, “social message” through messaging functionality on social networks such as Facebook®, or other such communications modes. As discussed in greater detail below, in an example embodiment, connectivity between with a user's email, SMS, instant message, social message or other communications accounts and platforms may be provided, for seamless integration and transmittal of information to and from such accounts. Such messages may include graphical or textual presentations of promotion components, coupon components and other information, as well as links or directions to facilitate access to business profiles and marketing elements such as promotion components and coupon components or other information that are generated and/or stored as discussed above. In such an embodiment, leads may be generated and other data may be gathered from recipients of such communications as discussed above in connection with the business profiles and marketing elements.

It is to be appreciated that embodiments of the invention may include functionality for connecting with third-party platforms and networks, such as Facebook®, Constant Contact® and Twitter®. For example, connectivity may be provided through applications programming interfaces (APIs) or other modes as are known in the art for facilitating such connections. Furthermore, such third-party platforms and networks may require particular information or data from a user to connect. Various modes of prompting a user for such information may be provided in embodiments of the invention. For example, a user may be prompted for specific information when attempting to connect with or access such third-party networks and platforms. Alternately, a user may be prompted to fill out a “click and complete” form (described in greater detail, below), or presented with some other interface for gathering data. The data collected from the user may be stored in a central storage location, in similar fashion as contact information business profiles and marketing elements, for convenient retrieval when needed to connect with such third-party network or platform. Any methods of gathering and storing information and data for such purposes, as may be known in the art, may be included in embodiments of the invention.

The connection and engagement with various media and informational channels, such as content networking, email, directory listings and other advertising channels and may be facilitated in an example embodiment through the use of the channels' respective application programming interfaces or other connection tools. In addition, hyperlinks may be provided to a user for accessing particular pages of such channels, where a user may enter identifying and account information and proceed to post content or incorporate links into a user's pages within such channels, or otherwise access an account or functionality provided by the channel to do so. Methods for such connectivity, engagement and access are well known in the art. Detailed descriptions are beyond the scope of this disclosure and are not necessary for understanding embodiments of the invention.

Data and information gathered from viewers and recipients of communication in the various example embodiments may be searched and analyzed, and made available throughout all aspects of such embodiments, as illustrated at block 42 of FIG. 1. For example, data collected through lead generation forms or from message recipients and viewers of social, advertising and business listing networks and websites may be stored in a centrally accessible storage medium, such as a database, for example. The information may be stored in a common storage medium with other data and information generated (e.g., business profiles, marketing elements, etc.) and gathered (e.g., user information, email and social network platform connectivity information, etc.), in connection with embodiments of the invention. Such data may include items such as the number of clicks on respective business profiles, marketing elements and related links that are posted to social networking business listing and other advertising webpages. Information gathered and stored in connection with some particular function of embodiments of the invention (e.g., through distribution of a business profile and marketing elements through social media), may be sorted and made available for utilization by the user in other functions, such as generating a new pay-per-click advertising campaign or in formulating a strategy for content distribution through e-mail, or directory listings, for example. A user may find it particularly useful to access this data in order to generate new distribution lists for promotions and marketing communications, or to analyze the performance of prior promotional activity and messages. Such accessibility to the gathered information may also facilitate sorting and grouping of contacts and leads by geography, business type, purchase frequency, and other known criteria for sorting marketing data and sales leads. In addition, contact data and other items stored in a storage medium as provided in embodiments of the invention may be exported for other uses.

As illustrated at block 44 of FIG. 1, an embodiment of the invention may also provide for the sale of products and/or services electronically or over electronic networks via e-commerce. In another embodiment, separate e-commerce functionality, such as through a third-party platform or an integrated e-commerce facility may be provided for deployment as directed by a user. Such an embodiment may provide for a seamless connection path for a viewer to navigate or transition from a business profile, promotion component or coupon component to an e-commerce facility, such as by clicking a hyperlink provided on the user interface of a computer or other Internet-connected device, for example. In this way, a viewer of generated content may quickly access products or services that are available for purchase, and the e-commerce functionality provided by this embodiment, whether integrated, or through access to a third-party e-commerce facilitator, may facilitate the transaction. In addition, as previously discussed, a user may specify that business profiles, marketing elements, lead capture forms and other messages and information as disclosed in connection with embodiments of the invention be transmitted to buyers of such products and services.

Various embodiments of the invention thus provide an integrated, end-to-end promotional and lead generation solution. Based on user input, certain embodiments may facilitate the synchronized, interconnected design of promotional materials, the development and management of promotions and promotional campaigns, the distribution of promotional materials over various media platforms and informational channels, the gathering of data from customers and prospects, and the sales of products and services, along with the sharing of gathered, entered, and generated information and data among all functions and functionality provided in embodiments of the invention. Integration of promotional and lead-building functions also provides for efficient performance tracking, as illustrated at block 46 of FIG. 1. In an example embodiment of the invention, integration of the various functions and centralization of data collection generates a trove of data regarding viewers who may be existing or potential customers. In addition to the specific viewer data captured by the lead capture form, detailed information may be gathered through electronic and Internet advertising and messaging on the number of times promotional materials are accessed, how often linking functionality is engaged by viewers, and also the frequency with which promotions and coupons stimulate sales or are printed. Each time a viewer interacts with a device displaying promotional content generated and delivered in accordance with embodiments of the invention, the interaction generates data that may be gathered and stored.

The data and information that is gathered may be centrally stored, sorted and analyzed to measure the effectiveness of the promotions generated, and their distribution through the various media platforms and informational channels. These results can be summarized and considered by a user in developing new promotional content and campaigns, choosing among distribution modes, and evaluating the effectiveness of linked promotional content. In addition, it may be particularly advantageous for a user to retrieve or access particularly effective promotional materials for reuse at a later time. Analysis of gathered data may guide a user in editing stored promotional content to improve its effectiveness in future promotions and campaigns. The trends and patterns emerging from such analysis provide valuable “business intelligence” that is useful in optimizing promotional activity. Of course, numerous methods of such data collection and analytics are known. A detailed description of such methods is beyond the scope of this disclosure, and not necessary to understand embodiments of the invention.

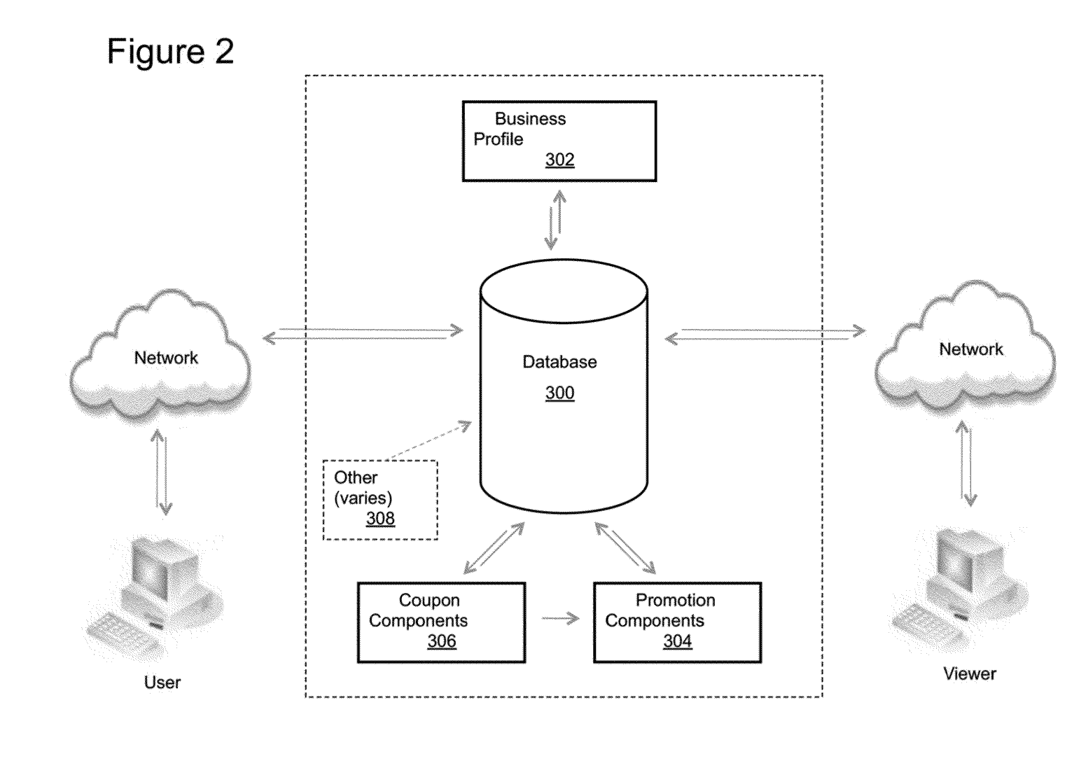

Referring now to FIG. 2, there is illustrated a block diagram of an example embodiment of the invention. Database 300 provides for centralized storage and accessibility of user-generated promotional content, as well as information regarding and gathered from viewers and recipients of such content. When a user generates a business profile 302, promotion component 304 or coupon component 306, the items themselves, along with related user-entered information may be saved and stored in database 300. In an example embodiment, any information (such as a business logo, text, video, or presentation, for example) entered in connection with generating a business profile 302, may be retrieved and utilized by a user when generating a promotion component 304 or coupon component 306. In similar fashion, any information entered by a user in connection with generating a promotion component 304 or a coupon component 306 may be stored in database 300. In an embodiment, any of these components may include hyperlinks to the others. For example, when a promotion component 304 is accessed, a hyperlink appearing in that promotion component 304 may launch the linked business profile 302 or coupon component 306 that is stored in database 300.

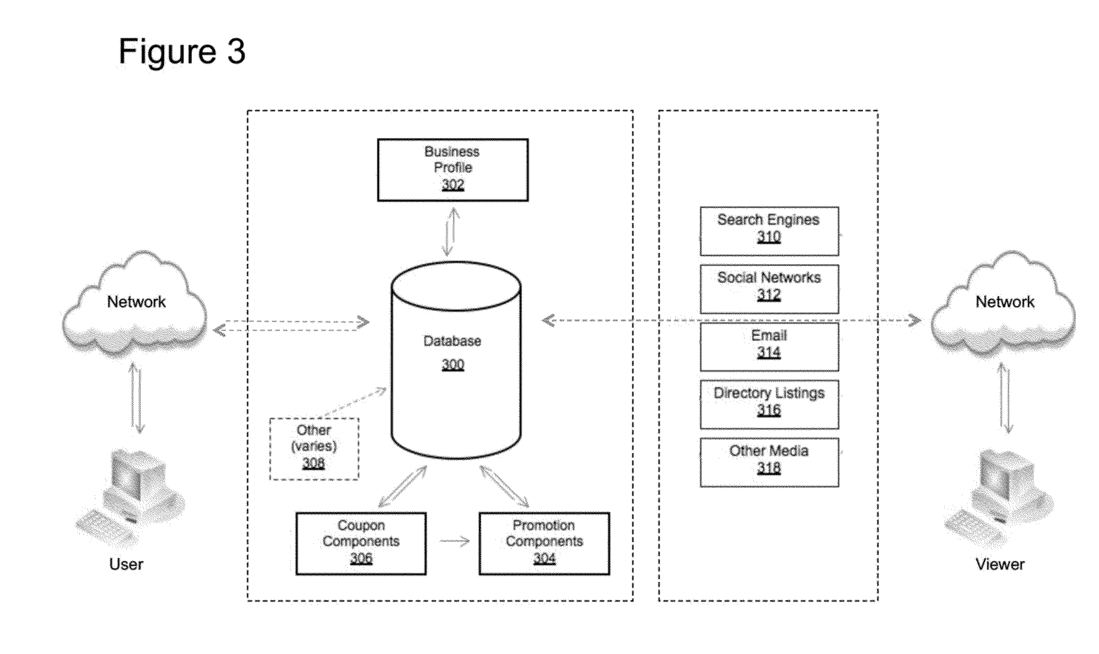

Providing for centralized storage of business profiles 302, promotion components 304 and coupon components 306 in a database 300, facilitates synchronization of information across the linked components. Any changes in the respective items in the database will be reflected when the component is accessed by a viewer. For example, if a user changes a business address or phone number on a business profile 302 that is linked to a coupon component 306, or the dates of a promotion as included in a particular promotion component 304, that is linked to a coupon component 306, the updated information will appear when a viewer launches these items through hyperlinks included in the respective linked coupon component 306, as is described in greater detail in connection with FIG. 3.

In an example embodiment illustrated in FIG. 3, interconnectivity with and access to information stored in database 300 is provided. For example, as discussed above in connection with FIG. 2, business profiles 302, promotion components 304 and coupon components 306, as well as related information, may be stored in database 300. Also as discussed above, these items may be linked to form linked sets. In addition, an example embodiment may provide for interconnectivity between database 300 and a search engine 310, a social network 312, email distribution facilities 314, directory listings 316 and other media 318. As discussed above, such networks, facilities, directories and platforms may require unique information from users for access, posting, or distribution of content. Such platform or network access data may be gathered and stored in database 300 as data components 308, for automatic retrieval and access, when needed for streamlined connectivity with such respective platforms and networks. Such interconnectivity may provide for information stored in the database to be distributed to and through media platforms and informational channels such as a search engine 310, a social network 312, email distribution facility 314, directory listing 316 and other media 318, as discussed above. For example, as directed by a user, a business profile 302 that is stored in database 300 may be accessed by a viewer via a search engine 310. Similarly, a promotion component 304, to which a coupon component 306 may be linked, may be posted to a user's page on a social network 312. When a viewer of the coupon component 306 via the social network clicks on a hyperlink to the promotion page 304, the respective promotion page 304, as stored in database 300, is launched. As discussed above in connection with FIG. 2, storage and access of information in database 300 facilitates synchronization among the various promotional items, data and information in database 300, so that synchronized information may be provided and transmitted to viewers. The synchronization, connectivity and various information exchanges among user, viewer, business profiles, marketing elements and other items, as illustrated in FIGS. 2 and 3, and in other embodiments, may be facilitated over networks, such as the Internet, for example.

In an embodiment of the invention, information stored in database 300 may be accessible in whole or in part. For example, individual elements of a particular business profile, marketing element or promotional communication, such as a photo, video or other presentation, or business street address or contact information, may be made individually publishable, retrievable or distributable from database 300.

In an example embodiment, as illustrated in FIG. 3, database 300 may receive information that is gathered from viewers and recipients of business profiles, marketing elements, and promotional communications and information. As discussed above, viewers of business profiles and marketing elements and recipients of promotional information and communications may provide information via lead generation forms. Such viewer information, along with other data, such as viewer click and e-commerce buying patterns, for example, may be retrieved from search engines 310, social networks 312, email platform 314, business directories 316, etc., and stored in database 300. As discussed above, such information may be useful in analyzing performance of promotional activity, communications and materials, identifying new customer leads, and building new promotions.

Of course, database 300 may be protected from intrusion and unauthorized data access by security measures that are well known in the art. In addition, in example embodiments of the invention, communications and interconnectivity between users, viewers, storage media such as a database, for example, and all other items described in connection with embodiments herein, such as business profiles, marketing elements, search engines, social networks, search engines, email platforms, directory listings, etc., may be facilitated through various networks and portals, whether direct-wired, private, public, secured, local, wide-area, unsecured, or wireless, for example (as discussed in greater detail, below).

In an example embodiment of the invention, a user may generate a preconfigured promotional “suite” that may include access through a storage medium, such as database 300 (illustrated in FIG. 3), for example, to particular integrated components, connections and functionality as described in embodiments herein (such as, for example, a business profile, promotion components, coupon components, communication templates, e.g., for email, SMS, instant messaging and social messaging, etc., and other promotion and communication elements described in embodiments herein, as well as connections and connectivity to social networks, directory listings, email platforms, search engine functionality and other media described in embodiments herein). Access to these materials may be extended to distributors, subsidiaries, and affiliates or other parties that may have aligned business interests (e.g., that have some sort of relationship or arrangement to provide similar services or products; although a formalized corporate interrelationship is not necessary). Such entities may thus be enabled to utilize the materials for a much broader scope of coordinated and synchronized promotional activities as described in embodiments herein, than such entities could accomplish on their own.

Access to the suite may be granted in different ways as is known in the art, and access to functionality and promotional materials in the suite, as well as to database 300 (illustrated in FIG. 3) may be limited or expanded as desired by the creator of the suite materials. For example, a copy of the suite with pre-populated information may be provided, for a distributor or other entity to edit, customize, and finalize. The distributor or other entity may fill in its specific information such as business type, business contact information, etc., and thus generate more customized materials based on those provided in the suite. In any case, access to such a pre-prepared suite may be provided in any number of ways, as is known in the art, such as, for example, password-protected access, etc.

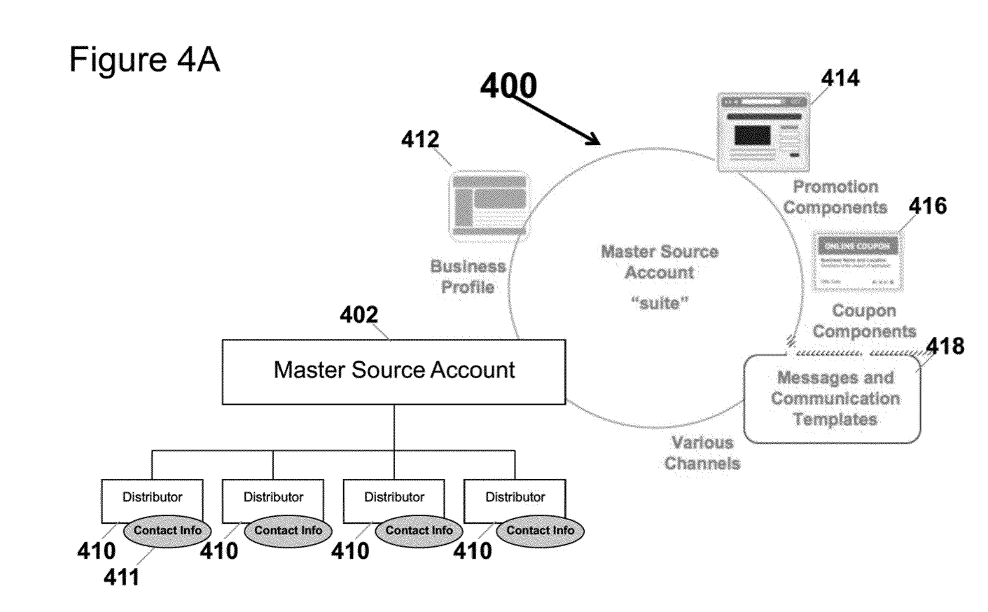

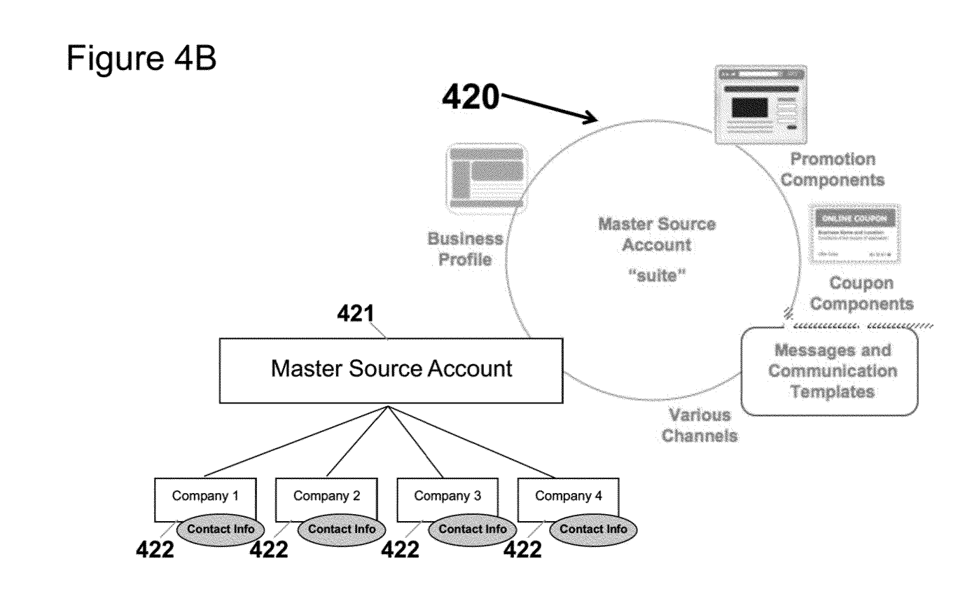

As an example illustrated in FIG. 4A, a swimming pool parts and service business (user) may grant access to such a preconfigured suite 400 of materials through a master source account 402 managed by the user, to 4 distributors 410, which may find it beneficial to utilize the preconfigured suite materials without having to generate them “from scratch,” and to leverage the various network and media connections provided by the user. In an embodiment, the user may populate the master source account 402 with all, or only a portion of the suite materials that the user desired to make accessible; and distributors 410 may access and utilize this content as permitted by the user. A distributor 410 may activate its own account so that it may edit, customize and utilize materials in the suite 400 that are provided to distributor 410. A copy of the suite materials may thus be provided to a storage medium, such as database 300 (illustrated in FIG. 3), which may be accessible through the account of a distributor 410. Suite 400 may include a set of one or more business profiles 412, a set of one or more promotion components 414, a set of one or more coupon components 416, and a set of one or more electronic communication messages and templates 418, all of which may have been generated in advance, and any of which may be further customizable by a distributor 410 as discussed above. In an embodiment, the materials may be provided to a distributor to input its contact information 411, or any other information authorized/allowed by the user who generated the suite. The materials in the suite 400 may be stored in storage media, such as database 300 (illustrated in FIG. 3), for example, and a copy may be provided to distributors 410 so that they may utilize, customize or modify the these materials for distribution and communication through their own networks, media platforms and informational channels, and through networks and other such channels established by the user, as described in various embodiment herein. That is, distributors 410 may distribute and communicate promotional materials and messages through their own social networks, email services, advertising services, search engines, etc., in addition to the informational channels, networks and media platforms that may have been set up by the user who generated the suite. The individual distributors 410, may also contribute information regarding their own contacts to the suite, for storage, such as in database 300 (illustrated in FIG. 3), for example. Distributors 410 may also gather and store information and data, as described in embodiments herein, from viewers of items in suite 400 that are deployed by the distributors 410. By doing so, businesses utilizing the suite may leverage a much wider distribution and communication network for business and lead generation, which may benefit all of the involved businesses and the user.

In another example embodiment, as illustrated in FIG. 4B, a suite 420 may be set up so that any number of businesses in a particular field may access a suite of materials through a master source account 421, in similar fashion as discussed above, in the “distributor” example. For example, a number of accounting firms 422 may access a suite 420 of such materials set up for accounting firms. Firms 422 accessing suite 420 may receive access to, or copies of, pre-generated materials that include promotional content tailored to accounting firms, which firms 422 may duplicate, customize and finalize for promotion and marketing as discussed in example embodiments herein, including without limitation, embodiments described in connection with the “distributor” model described above. In an embodiment, the suite and materials are not necessarily generated by a user in the same line of business, but may be otherwise generated, based on “business intelligence” gathered from businesses in the particular field, for example, and made available so that companies in the particular line of business may avail themselves of the functionality, as users.

In embodiments, the creator of the materials in the suite 400, 420 may also provide updates and new materials such as business profiles, promotion components and coupon components, etc., or access thereto, to distributors 410 or other entities that have access to the suite, or that have received copies of the suite materials as described above.

It is to be appreciated that each aspect, function and functionality of embodiments of the invention, such as, for example, displaying generated content, facilitating capturing customer leads, deploying and transmitting generated promotional content, providing for the sale of products and services, interfacing with social networks, electronic commerce and advertising and messaging media and platforms, may be interconnected and integrated with all others. These aspects, functions and functionality may interact with each other through various types of connectivity, and in a defined sequence, or randomly, as may be needed to provide, access, store or display information. Content, data and information may thus flow between and among any aspects, functions and functionality that gather, require, utilize, transmit or display particular information such as user data, information regarding products for sale, promotional content or any other information stored, generated or accessed by embodiments of the invention.

### Screenshots

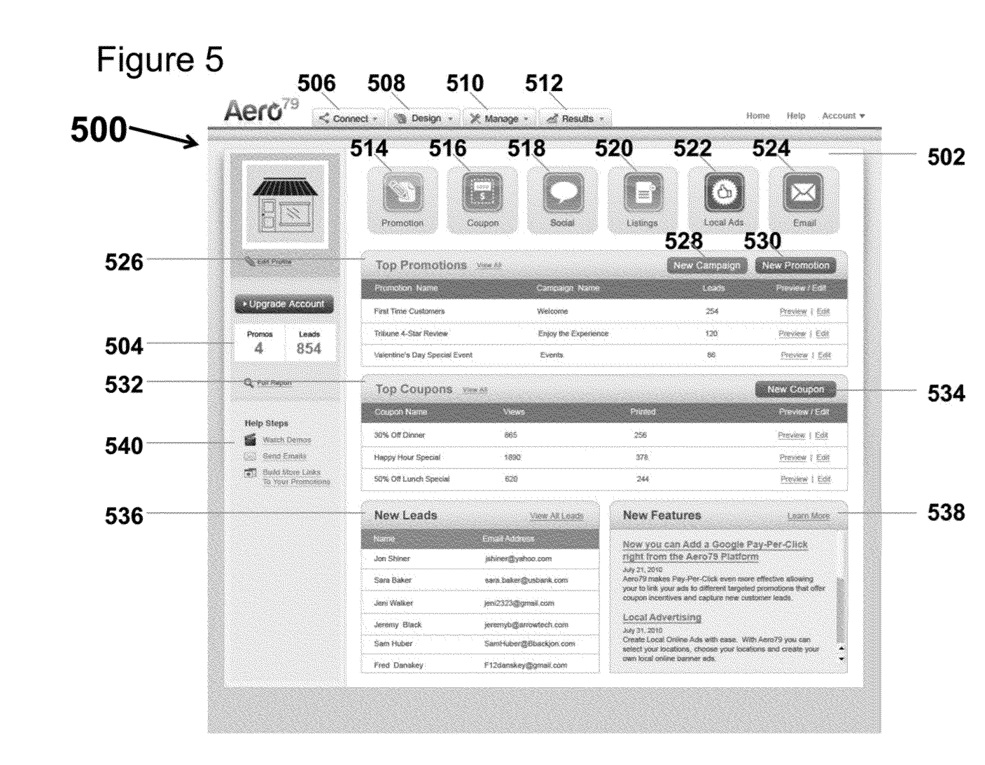

Aspects of various embodiments of the invention are shown as FIGS. 5-10, illustrating screenshots of webpages that function as components and user interfaces of example embodiments.

In an embodiment of the invention, a graphical user interface may be utilized by a user to control and manage aspects of content generation, access distribution, and storage in connection with embodiments of the invention. For example, FIG. 5 illustrates a screenshot of a graphical user interface, or webpage 500 that is configured as a “dashboard” 502. Dashboard 502 may include icons and buttons that allow a user to access functional aspects of embodiments of the invention. Dashboard 502 may also provide performance metrics to a user such as information regarding lead generation, access and response to business profiles and marketing components, as well as promotion performance. For example, display 504 may provide a user with up-to-the-minute information regarding the number of number of promotions a user has developed, and how many leads have been generated as a result.

Dashboard 502 may also include tabs 506, 508, 510 and 512, which link to more detailed functional pages and interfaces that allow a user to access and control particular features and functionality of embodiments of the invention. For example, tab 506 (“Connect”) may lead to functionality for communicating and distributing promotional content. Tab 508 (“Design”) may lead to functionality for developing and generating content such as a business profile or marketing components. Tab 510 (“Manage”) may lead to functionality for managing promotions and campaigns, such as setting timing and price parameters, for example. And, tab 512 (“Results”) may lead to functionality that allows a user to track the performance of promotions and campaigns. Dashboard 502 thus may provide a single interface from which a user can access all functions and functionality provided by embodiments of the invention to manage synchronized promotional activities and campaigns, from end-to-end.

For example, dashboard webpage 502 may include buttons that lead to other functions available in accordance with embodiments of the invention, as discussed above. Button 514 may lead a user to pages or functionality for generating and managing promotion components. Similarly, button 516 may lead a user to pages or functionality for generating and managing coupon components. Buttons 518, 520, 522, 524 may link a user to pages or functionality for managing listing directories and interfacing with third-party directories, managing social networks and interfacing with third-party social networks and managing content and execution of local advertising, and generating and distributing promotional messages via email, respectively. Other buttons may be included for additional functions.

Dashboard webpage 502 may also include windows for at-a-glance monitoring, managing and accessing other functions and functionality of embodiments of the invention in other ways. For example, window 526 may be directed to provide information regarding promotion components. It may include links 528, 530, to launch pages for generating a new campaign or a new promotion. In addition, window 526 may provide performance metrics such as details regarding the performance of promotions, such the number of leads generated by a particular promotion, and may display a list promotion components in order of best performance.

Similarly, dashboard 502 may include a window 532 including information with respect to coupon components. Window 532 may include information such as the number of times particular coupon components have been viewed or printed. Similarly to window 526, window 532 may include a button 534 for launching webpages or functionality for generating new coupon components. Also, dashboard 502 may include a “New Leads” window 536 that includes information regarding lead new leads that are generated or viewer data that has been gathered by the various aspects and functionality of various embodiments of the invention.

Dashboard 502 may also include windows such as window 538 that may display messages to a user regarding new functionality that may be provided as an update, as well as tips and tricks for accessing and utilizing functionality of which a user may not be fully aware.

Dashboard 502 may also include a “help section,” as is generally identified at 540. A “help section” may include hyperlinks to explanatory videos demonstrating operation of the functionality, as well as links that lead a user to other suggestions, assistance and tips, such as text-based instructional pages, for example, that may assist a user in utilizing functionality for sending emails, and other helpful information. It is to be appreciated that any or all of the information presented to a user via dashboard 502 may be information or content from a storage medium, such as database 300 (illustrated in FIG. 3), for example, or it may be new or derived information or data, such as “business intelligence,” as described above, or performance metrics which may have been generated, gathered or otherwise obtained through embodiments of the invention.

In embodiments of the invention, users may input information via graphical user interfaces such as “click and complete” web pages. The creation, use and presentation of such webpages are well known in the art. A detailed discussion of the construction and operation of such webpages is beyond the scope of this disclosure and is not necessary to understand embodiments of the invention. Nevertheless, the following descriptions are provided as examples to illustrate various embodiments of the invention.

As is well-known in the art, web pages may be presented to users via computers, mobile electronic devices such as tablets, PDAs, smartphones, etc., and may include prompts and pull-down menus, data-entry fields into which the user inputs data, checkboxes to make selections, and other elements. A user may input, upload, enter, access, transfer, make selections, edit and update graphical and text data and information utilizing such web pages, as is well known in the art. It is to be appreciated that such graphical user interfaces facilitate a user's entry of, and access to, data and information stored in storage media such as a database 300 (illustrated in FIG. 3), for example, through the various embodiments of the invention. As discussed above, data and information stored within storage media such as database 300 (illustrated in FIG. 3), for example, may be accessed by, and distributed throughout all aspects and functions of embodiments of the invention. Moreover information input into the various graphical user interfaces, and all web pages, information and content generated in accordance with various embodiments of the invention, may be stored in database 300, illustrated in FIG. 3.

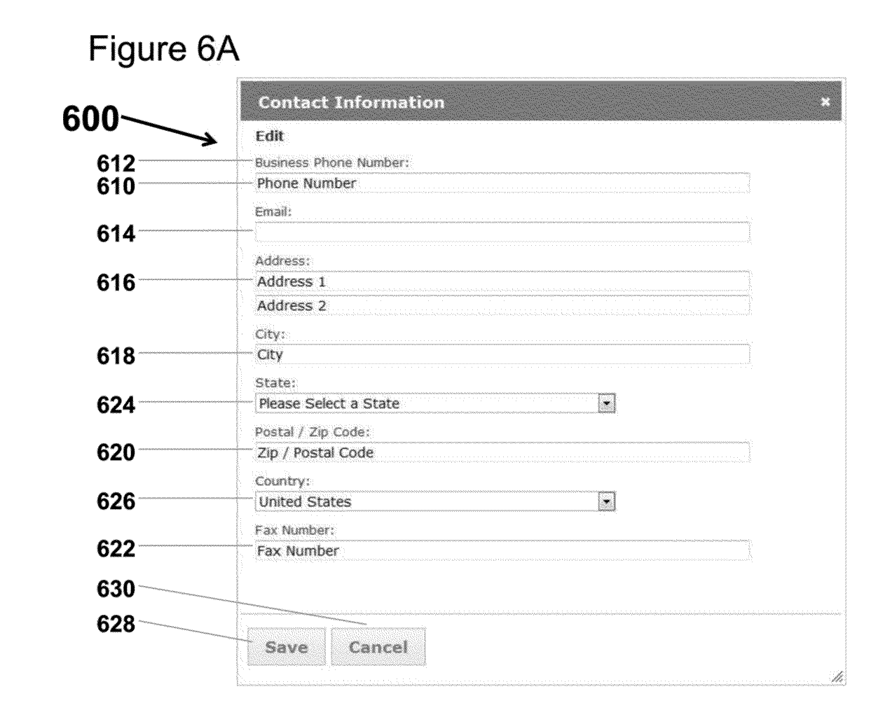

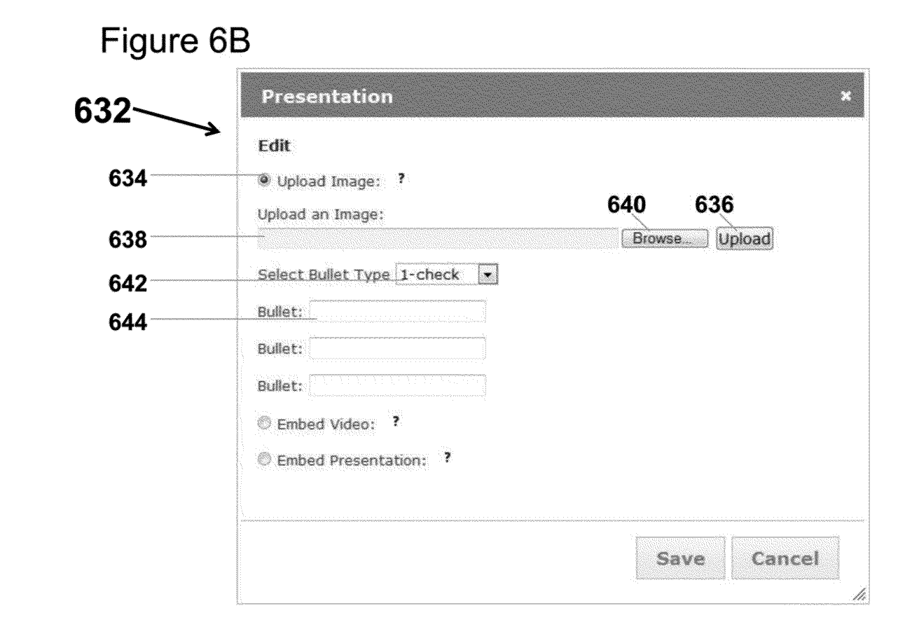

As an example, FIG. 6A illustrates a screenshot of a web page 600 that may be used to collect data from a user. Field 610 appears in proximity with a label 612 that prompts a user to enter a business phone number. Other fields 614, 616, 618, 620, and 622 prompt a user to input an email address, and elements of a physical address. The fields facilitate orderly collection and entry of data into a storage medium, such as database 300 (illustrated in FIG. 3), for example, for sorting and analysis according to the various separate elements input into each field. In addition to data entry-fields, web page 600 may include pull-down menus 624 and 626, for selection of pre-selected commonly used options such as “State” and “Country” elements of a street address. A web page 600 may also include buttons 628, 630, which a user can click to store the information entered, to access or activate particular functionality or to navigate away from the webpage 600, for example.

As another example, FIG. 6B illustrates a web page 632 that may facilitate the gathering of user-provided information that is used in generating a business profile or a marketing component in accordance with an example embodiment of the invention, and as described in greater detail, above. Clicking checkbox 634, in combination with clicking button 636, for example, allows a user to choose to input or upload images for use with the business profile page. After clicking checkbox 634, a user can input a filename into field 638, of an image to upload, or can click the “Browse” button 640 to access a directory of filenames that can be selected to automatically populate the field 638. Pull-down menu 642 and data-entry field 644 are elements that are well known in the art for use with such web pages, as described above.

It is to be appreciated that “click and complete” functionality may be deployed throughout all data-gathering functions and interfaces in embodiments of the invention, including, without limitation, where information is being collected from a user, a viewer, or a customer.

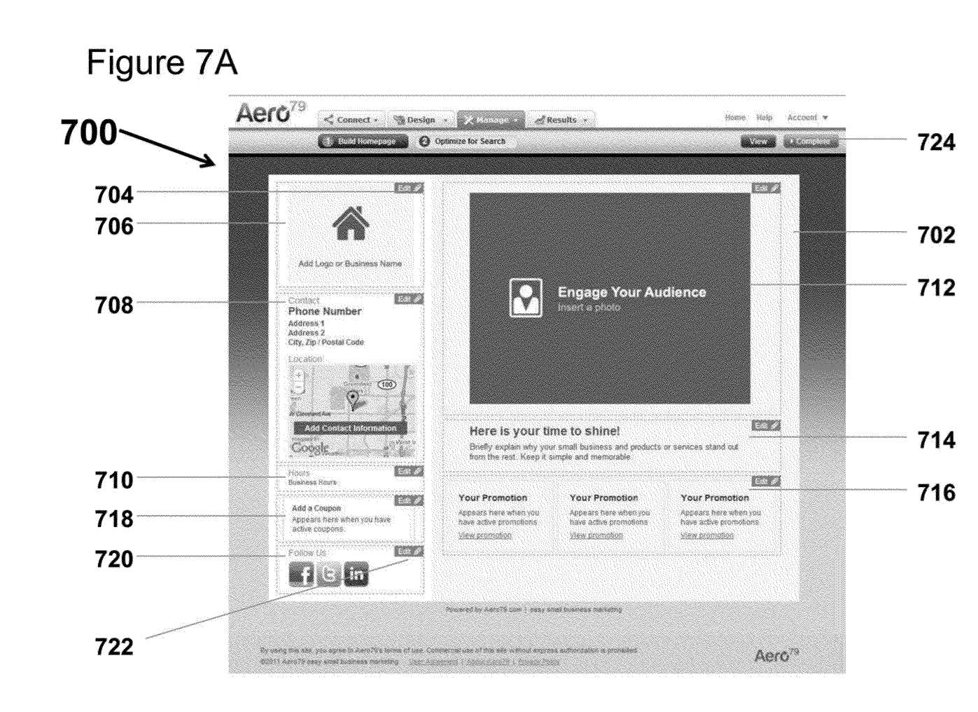

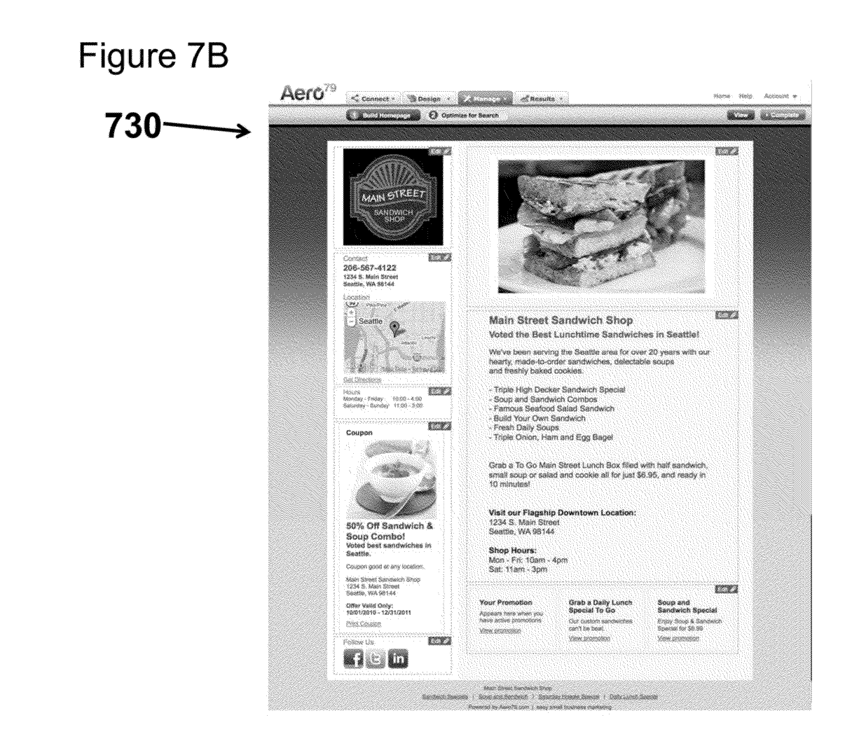

As illustrated in FIG. 7A, in connection with another example embodiment of the invention, a webpage user interface 700 may be presented to a user for collecting data that is used in building a customized business profile page. Webpage 700 facilitates the selection of specific business profile areas for editing or data entry, and the entry of images, text, hyperlinks and other data onto the business profile. Webpage 700 displays a template 702 that appears as the business profile will appear, and includes “windows” of the business profile that a user can build and edit. For example, clicking on the “Edit” tab 704 of window 706, may launch other pop-up windows or functionality (as is known in the art) that facilitate the uploading of a logo or business name from an existing file. Similarly, windows 708, 710, 712, 714, and 716 may provide or link to similar functionality that allows a user to make selections, input data, and upload graphics and other compatible items corresponding to the particular field (such as promotion components, in the case of window 716). As will be discussed in greater detail, below, window 718 may incorporate or link to functionality that allows a user to add a coupon component to the business profile template 702. It is to be appreciated that windows 716 and 718 may become populated with promotion components or coupon components, respectively, after a user enters, generates the respective marketing element or links it to the business profile template 702. In this regard, a user may also access and retrieve previously generated promotion components or coupon components (or links to them) from a storage medium such as database 300 (illustrated at FIG. 3), for example, for inclusion windows 716 and 718.

Window 720 may include icons of third-party systems or platforms (e.g., Facebook®, Twitter® and LinkedIn®, as shown in this example) to serve as links for directly connecting to, or launching the respective third-party systems, so that respective content posted on such systems or platforms may be accessed by a viewer of the completed business profile. Window 720 may be modified by clicking the “Edit” button 722 associated with window 720. As mentioned, template 702 allows user input to appear in a respective window on webpage 700 as soon as such items are uploaded, input, entered, or accessed from a storage medium such as database 300 (illustrated in FIG. 3) for example. The user can thus view and edit the appearance of such items through webpage 700 before the business profile is completed. Once user input and editing is completed, webpage 700 can be finalized and stored by clicking the “Complete” button 724. FIG. 7B illustrates a screenshot of a completed business profile webpage 730.

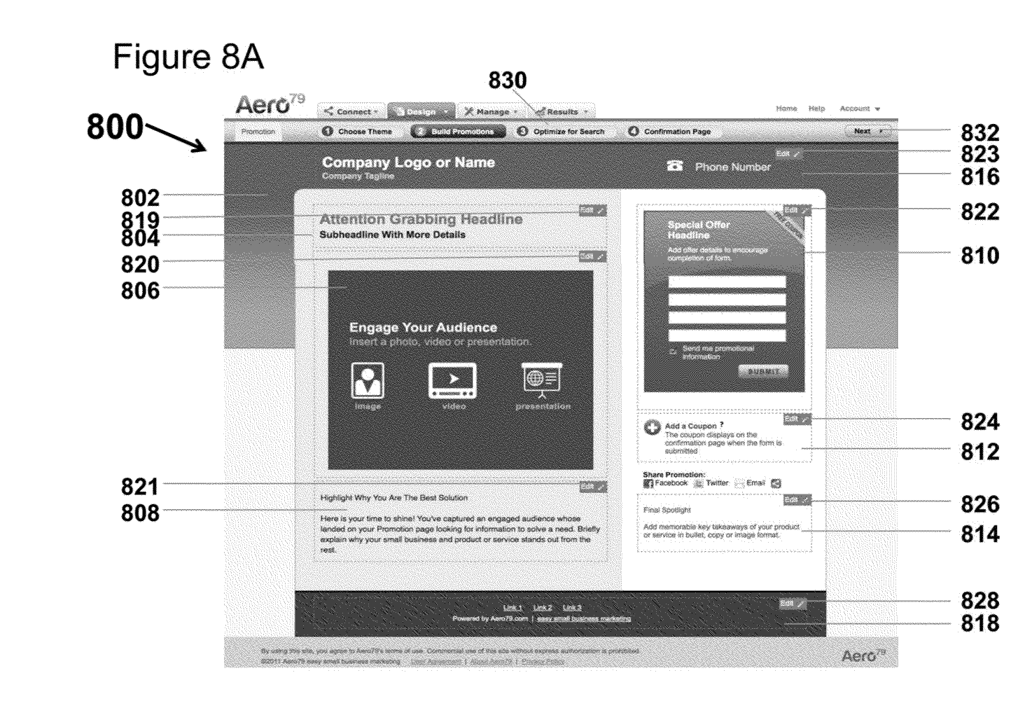

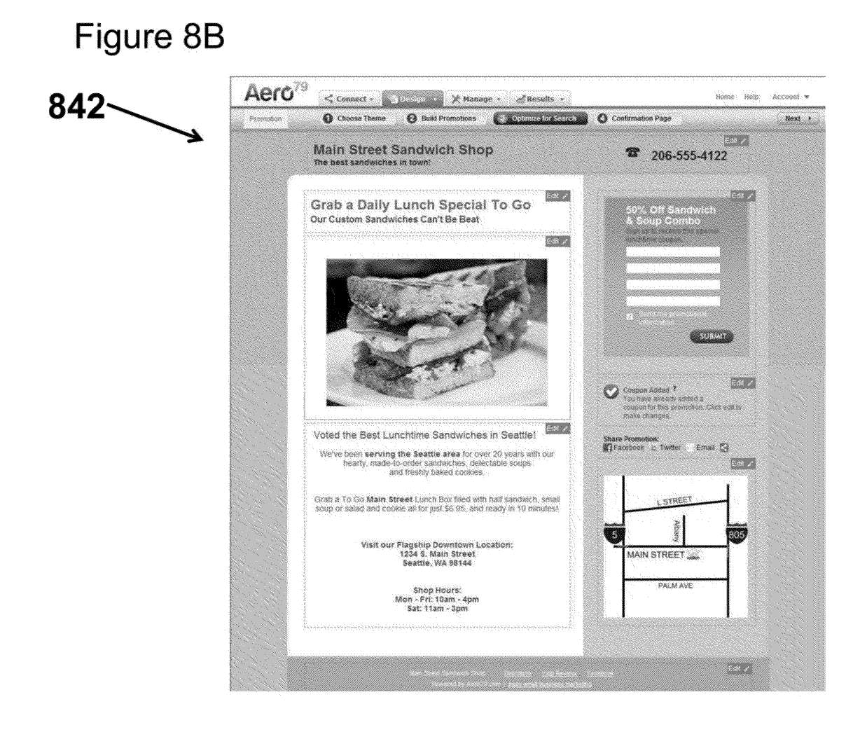

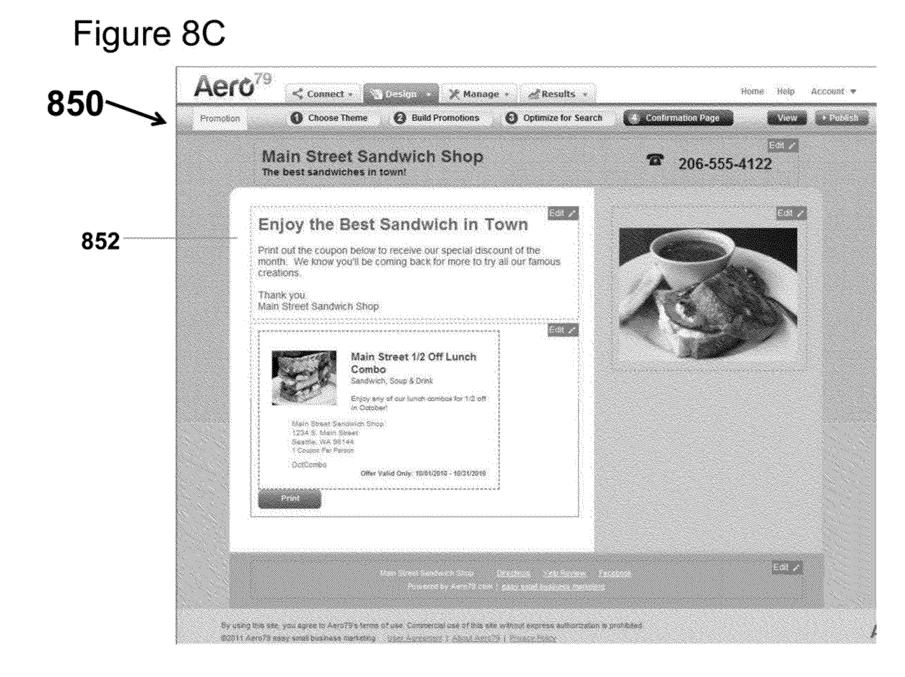

In an embodiment of the invention, as illustrated in FIGS. 8A and 8B, a user can design and build a customized promotion component by making selections and entering, uploading and inputting data and information. For example, FIG. 8A illustrates a screenshot of a graphical user interface, such as webpage 800, that includes a template 802 with windows 804, 806, 808, 810, 812, 814, 816 and 818 each of which may include an “Edit” button 819, 820, 821, 822, 823, 824, 826 and 828. Clicking the “Edit” button associated with a particular field may launch or activate other pop-up windows or fields for entering, uploading or selecting data into or in the respective field. It is to be appreciated that other modes of entering data into particular fields of graphical user interfaces are well-known in the art, and may be deployed in connection with template 802 for designing and building a promotion component.

Referring again to FIG. 8A, window 804 defines an area of template 802 where a user can input a custom headline. Similarly, window 806 defines an area for a user to include a photo, video or presentation, and the other windows 808, 810, 812, 814, 816 and 818 define areas for other items that may be useful and desirable in developing a custom promotion component. As discussed above, the template windows can be included in any number, and in any configuration. In addition, it is to be appreciated that information for the various template fields and windows may be uploaded or accessed from a storage medium such as database 300 (illustrated in FIG. 3), for example.

In similar fashion as described above, in connection with the business profile page, template 802 allows a user to view the appearance of a promotion component before it is finalized. Once the user is satisfied with the appearance of promotion component, as displayed in webpage 800, a user can click the “Next” button 832 to exit this webpage and move to the next step of developing the promotion component. FIG. 8B illustrates a screenshot of a completed business profile webpage 842.

Referring again to FIG. 8A, in an example embodiment of the invention, a next step may be optimization of a promotion component for search. In such an embodiment, a user can access the optimization functionality by clicking the “Optimize for Search” button 830. This may launch a “click to complete” window or page for a user to provide input regarding search terms, in similar fashion as discussed above, in connection with optimizing a business profile page for search. Similar functionality for “optimizing” a webpage for search may be included in webpages and interfaces for generating business profiles and coupon components, as well.

When all steps of developing and generating a promotion component have been completed to a user's satisfaction, the user may be led to a “Confirmation Page” 850, as illustrated in FIG. 8C. Completed template 852 includes user input within the desired template windows, and may have been optimized for search as discussed above. If the user is satisfied with the appearance of the promotion component, clicking the “Publish” button may store a copy of the completed promotion component in a storage medium such as database 300 (illustrated in FIG. 3), for example, and post a finalized version of the promotion component in a way and format that is accessible via the Internet. As discussed above, example embodiments of the invention may provide that such a promotion component may be automatically formatted to be accessible to various Web-enabled devices, such as computers, tablets, PDAs, smartphones, and the like. In addition, the completed promotion component may be stored in a storage medium such as database 300 (illustrated in FIG. 3), for example, for future uploading, access, or promotional use.

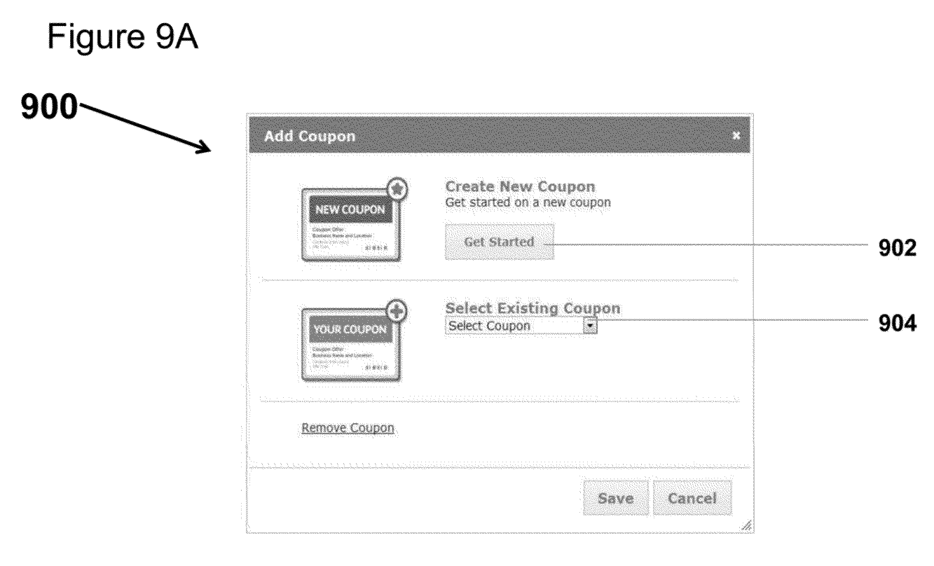

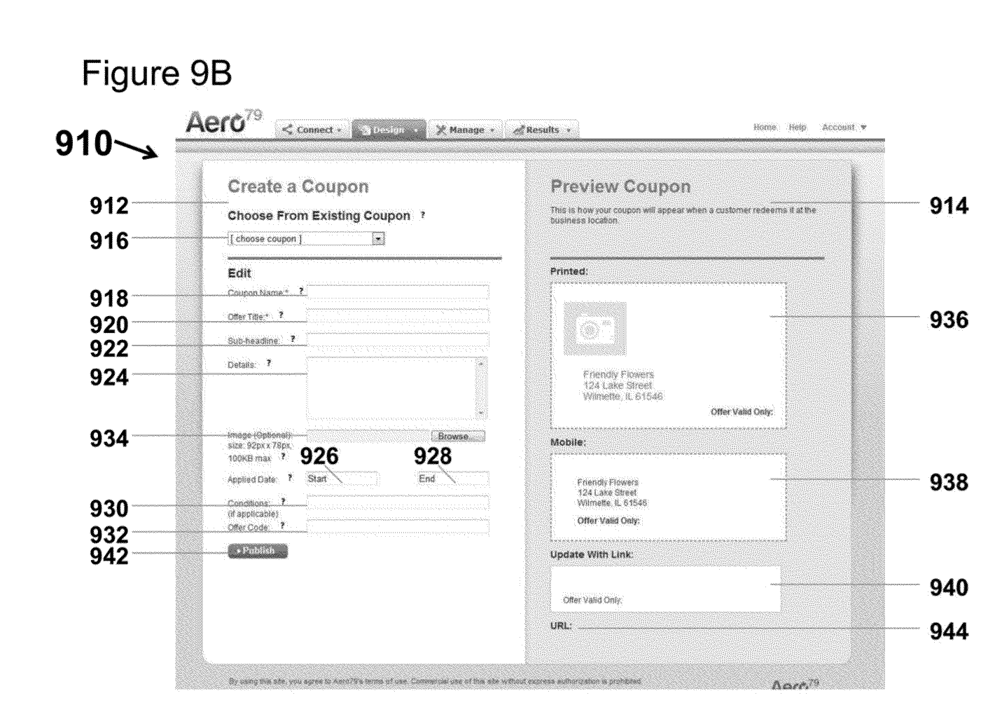

In another embodiment of the invention, coupon components may be generated and optimized for search through the use of graphical user interfaces, as in connection with the development of business profile pages and promotion components described above. Referring again to FIG. 5, clicking button 534 may launch an “Add Coupon” webpage or interface. FIG. 9A illustrates a screenshot of an “Add Coupon” graphical user interface, or webpage 900. On webpage 900, a user may choose to create a new coupon component, by clicking the “Get Started” button 902, or to select an existing coupon component, by selecting it from a menu of coupons stored in a storage medium such as database 300 (illustrated in FIG. 3), for example, and provided on webpage 900 as pull-down menu 904.

Clicking on the “Get Started” button 902, or selecting an existing coupon component from pull-down menu 904, may launch a “Create a Coupon” webpage 910, as illustrated as a screenshot in FIG. 9B. Webpage 910 may be split into a “Create a Coupon” section 912 and a “Preview Coupon” section 914. As discussed in connection with the graphical user interfaces for building a business profile page and a promotion component web page, a user can enter, import or upload customized data into the various fields. For example, the “Create a Coupon” section 912 may include a pull-down menu 916, which a user may access to access a previously-generated coupon component from a storage medium such as database 300 (illustrated in FIG. 3), for example, or other source, such as from a network, storage device or other storage media. A user may generate a new coupon component by modifying or updating a previously generated coupon component. The “Create a Coupon” section 912 may include additional data entry fields for a user to enter or input coupon component-identifying information such as “Coupon Name” in field 918, “Offer Title” in field 920, and other information in fields 922 and 924. Fields 926 and 928 may be configured to receive input from a user regarding the effective period of the coupon component, and fields 930 and 932 can receive additional information regarding conditions and an “Offer Code.” Field 934 allows a user to browse and select images from a storage medium such as database 300 (illustrated in FIG. 3), for example, or other or sources of image material, such as removable storage media or storage available via a network. Such images, such as a corporate logo or graphic depiction of a discounted item, for example, may be uploaded to appear in a coupon component generated by the user.

The “Preview” section 914 of webpage 910 allows a user to visualize how the coupon component appears, prior to finalizing the coupon component and publishing it online. For example, “Preview” page 914 may include fields 936, 938 and 940 to preview printed coupon components, mobile coupon components, or the term/validity of the offer, respectively. Field 944 may also display a URL assigned to the respective coupon component. The URL may be distributed through the various social media, electronic communications and informational channels and media, and other distribution channels and platforms in connection with embodiments of the invention. Once accepted by clicking the “Publish” button 942 displayed in section 912, the coupon component may be published through social media, electronic communication and informational channels, and other distribution channels and platforms facilitated by embodiments of the invention, as discussed above in connection with business profiles and promotion components. The completed coupon component may also be stored in storage media such as database 300 (illustrated in FIG. 3), for example, for archival purposes and later access and retrieval. As discussed above, stored coupon components may be accessed by various other aspects of embodiments of the invention in order to link coupon components to promotion components and business profiles, forming linked sets, or to distribute the coupon component or a respective hyperlink that facilitates access to the coupon component.

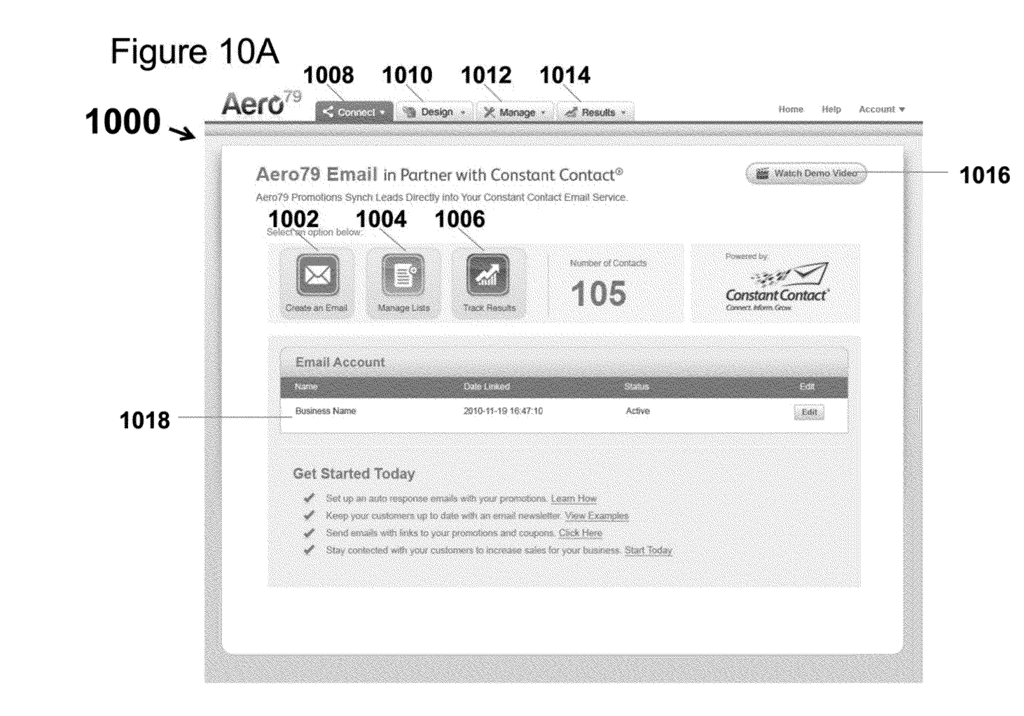

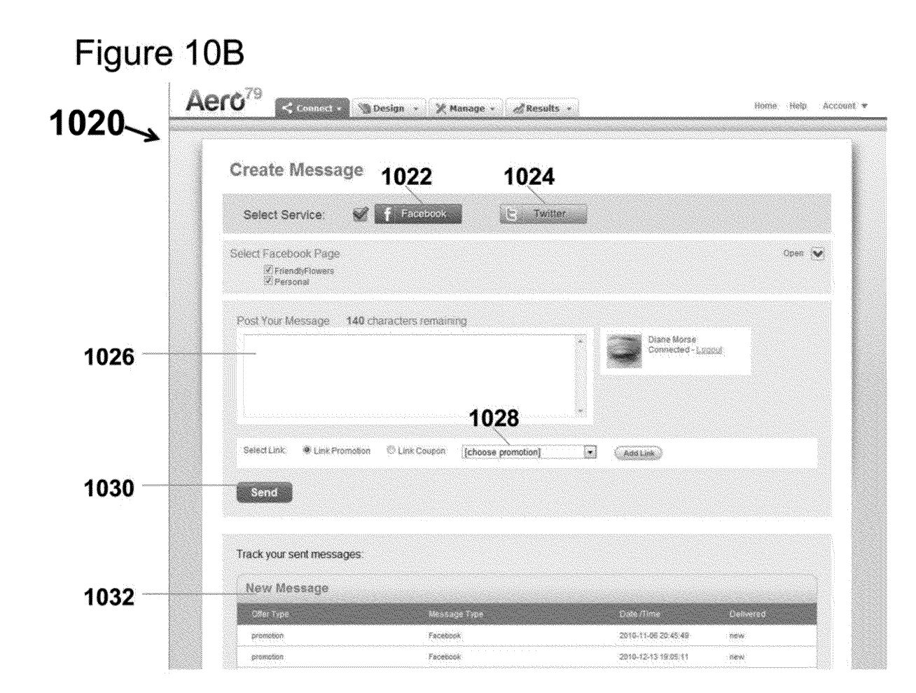

An example embodiment of the invention provides for the generation and distribution of e-mail messages, including through connectivity with a third-party service, such as Constant Contact®. FIG. 10A illustrates a screenshot of a webpage 1000 that provides for connectivity with Constant Contact®, so that the functionality of Constant Contact® may be utilized to distribute e-mails to a user's mailing list or email groups that have been entered or generated within Constant Contact®. Connectivity with Constant Contact® may be facilitated through an application programming interface or other developer tools. Connecting in this fashion provides for all of the advantages of embodiments of the invention discussed above, e.g., connectivity to items stored in a storage medium such as database 300 (illustrated in FIG. 3), for example, and transferability of content to and from Constant Contact®, such as promotional materials and information captured from email recipients. Through such connectivity, a user may interface with Constant Contact® within and through the interfaces of various embodiments of the invention. Similar connections, as are well known in the art, may facilitate interactivity and interoperability with other services and platforms provided by third-parties, such as Facebook®, Twitter®, and others, as discussed above.

As illustrated in FIG. 10A, webpage 1000 may include buttons and links as described in connection with other webpages, above. For example, webpage 1000 may include buttons 1002, 1004, and 1006, that link to or launch functionality for creating emails, managing lists and tracking results. As further illustrated in FIG. 10A, highlighted tab 1008 indicates that the user is operating within the “Connect” environment. Other tabs, 1010, 1012, and 1014 facilitate linking to other aspects of embodiments of the invention, namely the “Design,” “Manage,” and “Results” aspects discussed above. Button 1016 may facilitate linking to, or launch of, additional helpful information such as, for example, a demonstration video explaining the functionality of Constant Contact® within the environment of the described embodiments. Window 1018 may provide a user with information regarding a particular communication distributed through Constant Contact®.

Another example embodiment of the invention provides for the generation and distribution of content by sending e-mail, SMS messages, instant messages, social messages or other communication, such as via a user's Facebook® or Twitter® account. This may be facilitated through connectivity with such third-party services or platforms (e.g., Facebook® and Twitter®). As discussed, such third-party services and platforms may require unique input or information from a user, and such input or information may be stored in a storage medium such as database 300 (illustrated in FIG. 3), for example, for retrieval when needed by the third-party service. FIG. 10B illustrates a screenshot of a webpage 1020 that provides for connectivity with Facebook® and Twitter®, so that the functionality of these networks and platforms may be utilized to distribute content and communications to a user's mailing list, email groups, follower lists, etc. that have been entered or generated within Facebook® and Twitter®. Alternately, connectivity with such networks and platforms may facilitate access to a user's information regarding contacts, customers and leads stored on storage media such as database 300 (illustrated in FIG. 3), for example, so that messages and communications may be sent to these contacts. In addition, the promotional content may or may not be integrated or synchronized with other promotional content stored in storage media such as database 300 (FIG. 3), for example, or transmitted through other platforms or media. Webpage 1020 may include functionality as described in connection with other example embodiments herein, and may include a Facebook® link 1022 and Twitter® link 1024, for accessing such a third-party service for communicating a promotional message. Webpage 1020 may also include a field 1026 for composing a message, as well as buttons, checkboxes, pulldown menus, etc. which may facilitate the incorporation of various content into the message, including content from a storage medium such as database 300 (illustrated in FIG. 3), for example. At field 1028, a user can select a checkbox for “Link Promotion” or “Link Coupon,” which may facilitate the linking of a respective promotion or coupon to message. This may also be facilitated by a pull-down menu, as illustrated at field 1028. When the message text has been entered at field 1026, and any other items added at field 1028, a user can click the Send button 1030, to transmit the message to the respective Facebook® or Twitter® account. In addition, webpage 1020 may include a window 1032 for tracking sent communications. In an example embodiment, window 1030 may include information such as the type of offer included in the message, which third-party service or platform was used for its distribution, the date/time the communication was sent, and whether or not the communication was delivered.

As discussed above, embodiments of the invention facilitate interoperability with third-party services such as Constant Contact®, so that a user may publish, communicate or distribute promotional content that is new, or accessed from a storage medium such as database 300 (illustrated in FIG. 3), for example. Referring again to FIG. 10A, through webpage 1000, a user may generate an email for distribution through Constant Contact®. Since the user is still operating within an embodiment of the invention, the user may access business profiles and marketing elements, along with related information such as hyperlinks, to include in emails. In addition, customer and lead generation information that has been captured in other aspects of embodiments of the invention and stored in a storage medium such as database 300 (illustrated in FIG. 3) for example, may be accessed to generate mailing lists. In addition, and in similar fashion as described above, viewer information may be captured and received from recipients of Constant Contact® emails, such as through links to lead generation pages and collection of viewer click and purchase habits.

In an embodiment, promotional activities conducted through Constant Contact® may be synchronized with other promotional activities carried out in accordance with various embodiments of the present invention. For example, a user may specify that a promotional campaign is to include distribution of links to a business profile through Facebook® and business listing directories, distribution of coupon components through Twitter®, and distribution of related e-mail messages through Constant Contact®. The related promotional material, information and links may be stored in a storage medium such as database 300 (illustrated in FIG. 3), for example, and automatically distributed to and through these various platforms and channels, as directed by the user. Furthermore, the lead generation and data gathering activities may proceed as directed by the user, with the captured information automatically being captured and stored in a storage medium such as database 300 (illustrated in FIG. 3), for example.

### Computing Apparatus and Systems

It is understood that the various embodiments of the present invention may be implemented individually, or collectively, in devices comprised of various hardware and/or software modules and components. Such a device, for example, may comprise a processor, a memory unit, and an interface that are communicatively connected to each other, and may range from desktop, server and/or laptop computers, to consumer electronic devices such as mobile devices and the like. Such devices may include input and peripheral devices, and other components that enable the device to read and receive data and instructions from various media, input devices, a network, or other inputting means in accordance with the various embodiments of the invention. It should be understood, however, that the scope of embodiments of the present invention are not intended to be limited to one particular type of device.

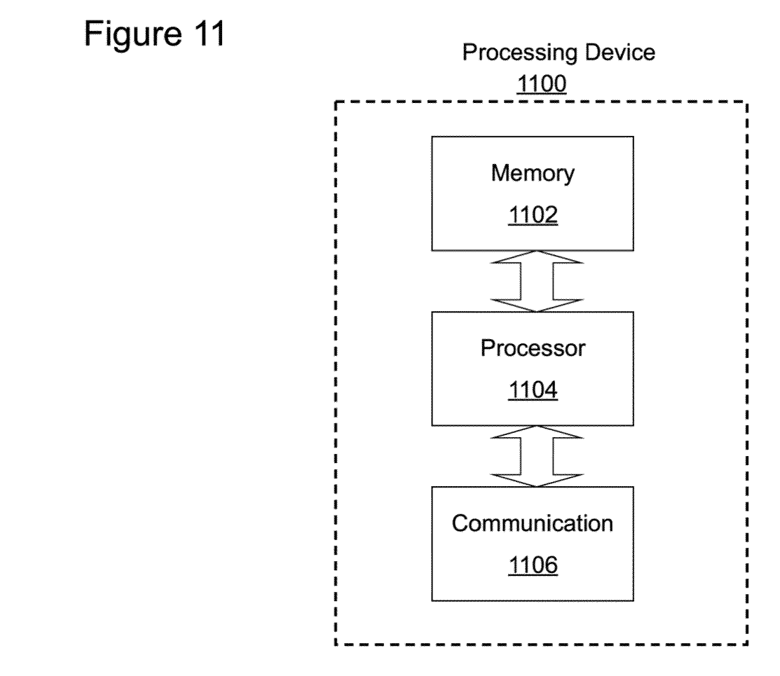

As an example, FIG. 11 illustrates a block diagram of a device 1100 within which the various embodiments of the present invention may be implemented. The device 1100 comprises at least one processor 1104 and/or controller, at least one memory unit 1102 that is in communication with the processor, and at least one communication unit 1106 that enables the exchange of data and information, directly or indirectly, with a communication medium, such as the Internet, or other networks, entities and devices. The processor 1104 can execute program code that is, for example, stored in the memory 1102. In another embodiment of the invention, the program code executed by the processor 1104 may be stored on a device or server that is remote from the processor and accessible through the exchange of data and information with a communication medium such as the Internet or other network. The communication unit 1106 may provide wired and/or wireless communication capabilities in accordance with one or more communication protocols and interfaces, and therefore it may comprise the proper transmitter/receiver antennas, circuitry and ports, as well as the encoding/decoding capabilities that may be necessary for proper transmission and/or reception of data and other information.

Similarly, the various components or sub-components within each module of embodiments of the present invention may be implemented in software, hardware, and/or firmware. The connectivity between the modules and/or components within the modules may be provided using any one of the connectivity methods and media that is known in the art, including, but not limited to, communications over the Internet, wired, or wireless networks using the appropriate protocols.

Various embodiments described herein are described in the general context of method steps or processes, which may be implemented in one embodiment by a computer program product or module, embodied in a computer-readable memory, including computer-executable instructions, such as program code, and executed by apparatus such as computers or computing systems in networked environments. A computer-readable memory may include removable and non-removable storage devices including, but not limited to, Read Only Memory (ROM), Random Access Memory (RAM), compact discs (CDs), digital versatile discs (DVD), etc. As such, the various disclosed embodiments can be implemented by computer code embodied on non-transitory computer readable media. In other embodiments processes may be employed to perform operations on data, wherein the instructions for process operations and the data, or elements thereof, may reside on or be transferred through one or more computing devices, systems or networks.

Generally, program products or modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions that, when executed by a processor, cause an apparatus to perform the methods and processes described herein. Apparatus or systems utilized in connection with embodiments of the invention may be of a general-purpose character, or may be specially constructed, designed or programmed for the required purposes. In embodiments of the invention, such apparatuses and systems may be configured or activated by computer programs, instructions and/or data stored in or transferred into the apparatus or system.

Embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of such a device described and depicted in FIG. 11. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from the practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method comprising:
(a) generating one or more business profiles based on content provided by a user;
(b) generating at least one marketing element based on content provided by the user;
(c) gathering information related to at least one viewer of at least one of the following: (i) one of the one or more business profiles; or (ii) at least one marketing element;
(d) analyzing the information related to the at least one viewer, the information relating to at least one of the following: (i) viewer characteristics or (ii) viewer actions; and
(e) making data related to the information available to the user.

2. The method of claim 1, further comprising distributing at least one of the following through at least one informational channel: (i) one of the one or more business profiles or (ii) at least one marketing element.

3. The method of claim 2, wherein the information related to the at least one viewer is gathered via the at least one informational channel.

4. The method of claim 3, further comprising quantifying performance metrics based on analysis of information related to the at least one viewer.

5. The method of claim 4, wherein making data available to the user includes making the performance metrics available to the user.

6. The method of claim 1, wherein at least one of the following is stored: (i) the user-provided content; (ii) at least one of the one or more business profiles; or (iii) at least one marketing element.

7. The method of claim 1, further comprising generating at least one linked set, each set including at least one of the at least one marketing element and at least one of the following: (i) one of the one or more business profiles; or (ii) at least one other marketing element.

8. The method of claim 7, further comprising linking at least one linked set to at least one media platform for distribution to at least one viewer via the at least one media platform.

9. The method of claim 1, further comprising:
generating a suite of promotional materials based on content provided by a user;
providing at least one other user with access to at least a portion of the suite;
wherein the access includes authorization to at least one of: (i) customize the promotional material; or (ii) distribute the customized promotional materials through informational channels.

10. The method of claim 9, further comprising providing the at least one other user with authorization to link customized promotional material to at least one media platform for distribution to viewers via the at least one media platform.

11. The method of claim 1, further comprising optimizing the business profile and marketing elements for ease of searchability via search engines.

12. The method of claim 2, further comprising making available for sale to at least one viewer, through the at least one informational channel, at least one of the following: (i) one or more products; or (ii) one or more services.

13. An apparatus comprising:
at least one processor; and
at least one memory including computer code, the at least one memory and the computer program code configured to, with the at least one processor, cause the apparatus to perform at least the following:
generate one or more business profiles based on content provided by a user;
generate at least one marketing element based on content provided by the user;
gather information related to at least one viewer of at least one of the following: (i) one of the one or more business profiles; or (ii) at least one marketing element;
analyze the information related to the at least one viewer, the information relating to at least one of the following: (i) viewer characteristics or (ii) viewer actions; and
make data related to the information available to the user.

14. The apparatus of claim 13, wherein the apparatus is further caused to distribute at least one of the following through at least one informational channel: (i) one of the one or more business profiles or (ii) at least one marketing element.

15. The apparatus of claim 14, wherein the apparatus is further caused to gather the information related to the at least one viewer via the at least one informational channel.

16. The apparatus of claim 15, wherein the apparatus is further caused to quantify performance metrics based on analysis of information related to the at least one viewer.

17. The apparatus of claim 16, wherein causing the apparatus to make data available to the user includes causing the apparatus to make such performance metrics available to the user.

18. The apparatus of claim 13, wherein the apparatus is further caused to store at least one of the following: (i) the user-provided content; (ii) at least of the one or more business profiles; or (iii) at least one marketing element.

19. The apparatus of claim 13, wherein the apparatus is further caused to generate at least one linked set, each set including at least one of the at least one marketing element and at least one of the following: (i) one of the one or more business profiles; or (ii) at least one other marketing element.

20. The apparatus of claim 19, wherein the apparatus is further caused to link at least one linked set to at least one media platform for distribution to at least one viewer via the at least one media platform.

21. The apparatus of claim 13, wherein the apparatus is further caused to:
generate a suite of promotional materials based on content provided by a user;
provide at least one other user with access to at least a portion of the suite;
wherein the access includes authorization to at least one of: (i) customize the promotional material; or (ii) distribute the customized promotional materials through informational channels.

22. The apparatus of claim 21, wherein the apparatus is further caused to provide the at least one other user with authorization to link customized promotional material to at least one media platform for distribution to viewers via the at least one media platform.

23. The apparatus of claim 13, wherein the apparatus is further caused to optimize the business profile and marketing elements for ease of searchability via search engines.

24. The apparatus of claim 14, wherein the apparatus is further caused to make available for sale to at least one viewer, through the at least one informational channel, at least one of the following: (i) one or more products; or (ii) one or more services.

25. A computer program product, embodied on a non-transitory computer-readable medium, comprising:
computer code for causing an apparatus to perform at least the following:
(a) generating one or more business profiles based on content provided by a user;
(b) generating at least one marketing element based on content provided by the user;
(c) gathering information related to at least one viewer of at least one of the following: (i) one of the one or more business profiles; or (ii) at least one marketing element;
(d) analyzing the information related to the at least one viewer, the information relating to at least one of the following: (i) viewer characteristics or (ii) viewer actions; and
(e) making data related to the information available to the user.
